(19) United States
(12) Patent Application Publication
(10) Pub. No.: US 2008/0284318 A1
(43) Pub. Date: Nov. 20, 2008

(54) HYBRID FLUORESCENT/PHOSPHORESCENT OLEDS

(76) Inventors: Joseph C. Deaton, Rochester, NY (US); Denis Y. Kondakov, Kendall, NY (US); Marina E. Kondakava, Kendall, NY (US); Kevin P. Klubek, West Henrietta, NY (US); Dustin L. Comfort, Hamlin, NY (US)

Correspondence Address: Andrew J. Anderson;Patent Legal Staff, Eastman Kodak Company, 343 State Street, Rochester, NY, 14650-2201, US

(21) Appl. No.: 11/749,899

(22) Filed: May 17, 2007

(51) Int. Cl. H01J 1/62

(52) U.S. Cl. 313/504

(57) ABSTRACT

An electroluminescent device comprises
a) a fluorescent light emitting layer comprising a fluorescent emitter and a fluorescent host material wherein the HOMO energy level of the fluorescent host material is not more than 0.1 eV more negative than that of the fluorescent emitter;
b) a phosphorescent light emitting layer comprising a phosphorescent emitter and a phosphorescent host material; and
c) a spacer layer interposed between the fluorescent light emitting layer and the phosphorescent light emitting layer;
wherein the triplet energy of the fluorescent host material is not more than 0.2 eV less than the triplet energy of both the spacer layer material and of the phosphorescent host material. The materials within these layers are selected so that the HOMO and triplet energy levels satisfy certain interrelationships. The invention provides devices that emit light with high luminous efficiency.

### CROSS REFERENCE TO RELATED APPLICATIONS

This application is being co-filed with applications entitled “HYBRID OLED WITH FLUORESCENT AND PHOSPHORESCENT LAYERS”, under Attorney Docket No. 93237AEK, and “HYBRID OLED HAVING IMPROVED EFFICIENCY”, under Attorney Docket No. 93685RLO.

### FIELD OF THE INVENTION

This invention relates to an organic light emitting diode (OLED) electroluminescent (EL) device comprising a hybrid fluorescent/phosphorescent structure wherein the blue fluorescent emission component is produced with high efficiency while simultaneously allowing energetically more favored diffusion of triplet excitons from the blue singlet emissive region to the phosphorescent emissive regions that can provide desirable electroluminescent properties such as high luminous and power efficiencies.

### BACKGROUND OF THE INVENTION

While organic electroluminescent (EL) devices have been known for over two decades, their performance limitations have represented a barrier to many desirable applications. In simplest form, an organic EL device is comprised of an anode for hole injection, a cathode for electron injection, and an organic medium sandwiched between these electrodes to support charge recombination that yields emission of light. These devices are also commonly referred to as organic light emitting diodes, or OLEDs. Representative of earlier organic EL devices are Gurnee et al, U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, 30, 322, (1969); and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often >100V.

More recent organic EL devices include an organic EL element consisting of extremely thin layers (e.g. <1.0 μm) between the anode and the cathode. Herein, the term “organic EL element” encompasses the layers between the anode and cathode. Reducing the thickness lowered the resistance of the organic layers and has enabled devices that operate at much lower voltage. In a basic two-layer EL device structure, described first in U.S. Pat. No. 4,356,429, one organic layer of the EL element adjacent to the anode is specifically chosen to transport holes, and therefore is referred to as the hole transporting layer, and the other organic layer is specifically chosen to transport electrons and is referred to as the electron transporting layer. Recombination of the injected holes and electrons within the organic EL element results in efficient electroluminescence.

There have also been proposed three-layer organic EL devices that contain an organic light emitting layer (LEL) between the hole transporting layer and electron transporting layer, such as that disclosed by C. Tang et al. (J. Applied Physics, Vol. 65, 3610 (1989)). The light emitting layer commonly consists of a host material doped with a guest material, otherwise known as a dopant. Still further, there has been proposed in U.S. Pat. No. 4,769,292 a four-layer EL element comprising a hole injecting layer (HIL), a hole transporting layer (HTL), a light emitting layer (LEL) and an electron transporting/injecting layer (ETL). These structures have resulted in improved device efficiency.

Many emitting materials that have been described as useful in an OLED device emit light from their excited singlet state by fluorescence. The excited singlet state can be created when excitons formed in an OLED device transfer their energy to the singlet excited state of the emitter. However, only 25% of the excitons created in an EL device are singlet excitons. The remaining excitons are triplet, which cannot readily transfer their energy to the emitter to produce the singlet excited state of a emitter. This results in a large loss in efficiency since 75% of the excitons are not used in the light emission process.

Triplet excitons can transfer their energy to an emitter if the emitter has a triplet excited state that is low enough in energy. If the triplet state of the emitter is emissive it can produce light by phosphorescence. In many cases, singlet excitons can also transfer their energy to the lowest singlet excited state of the same emitter. The singlet excited state can often relax, by an intersystem crossing process, to the emissive triplet excited state. Thus, it is possible, by the proper choice of host and emitter, to collect energy from both the singlet and triplet excitons created in an OLED device and to produce a very efficient phosphorescent emission. The term electrophosphorescence is sometimes used to denote electroluminescence wherein the mechanism of luminescence is phosphorescence.

Another process by which excited states of an emitter can be created is a sequential process in which a hole is trapped by the emitter and subsequently recombines with an electron, or an electron is trapped and subsequently recombines with a hole, in either case producing an excited state of the emitter directly. Singlet and triplet states, and fluorescence, phosphorescence, and intersystem crossing are discussed in J. G. Calvert and J. N. Pitts, Jr., Photochemistry (Wiley, N.Y., 1966) and further discussed in publications by S. R. Forrest and coworkers such as M. A. Baldo, D. F. O'Brien, M. E. Thompson, and S. R. Forrest, Phys. Rev. B, 60, 14422 (1999) and M. A. Baldo, S. R. Forrest, Phys. Rev. B, 62, 10956 (2000).

Emission from triplet states is generally very weak for most organic compounds because the transition from the triplet excited state to the singlet ground state is spin-forbidden. However, it is possible for compounds with states possessing a strong spin-orbit coupling interaction to emit strongly from triplet excited states to the singlet ground state (phosphorescence). For example, fac-tris(2-phenyl-pyridinato-N,C^{2′}-)Iridium(III)(Ir(ppy)₃) emits green light (K. A. King, P. J. Spellane, and R. J. Watts, J. Am. Chem. Soc., 107, 1431 (1985); M. G. Colombo, T. C. Brunold, T. Reidener, H. U. Güdel, M. Fortsch, and H.-B. Bürgi, Inorg. Chem., 33, 545 (1994)). Additional disclosures of phosphorescent materials and organic electroluminescent devices employing these materials are found in U.S. Pat. No. 6,303238 B1, WO 2000/57676, WO 2000/70655, WO 2001/41512 A1, WO 2002/02714 A2, WO 2003/040256 A2, and WO 2004/016711 A1.

OLEDs employing phosphorescent emitters are capable in principle of achieving 100% internal quantum efficiency because they are capable of harvesting all of the excitons (both electron spin singlets and triplets) produced by injection of electrical charge into the device as light emission. On the other hand, OLEDs employing fluorescent emitters are generally capable achieving only up to 25% internal quantum efficiency because they are capable of harvesting only the singlet excitons. Unfortunately, OLEDs utilizing blue phosphorescent emitters have been deficient in operational stability and therefore not suitable for most practical uses. Therefore, OLEDs combining especially blue fluorescent emitters with longer wavelength phosphorescent emitters have been sought as a practical alternative to achieving high efficiencies in white light producing devices. Many of the proposed device structures appear to simply divide the electron and hole recombination events resulting from electrical charge injection among emissive layers comprising the fluorescent emitters and emissive layers comprising phosphorescent emitters. The potential efficiencies of these devices are limited because the triplet states formed by recombination within the fluorescent emissive layer would not be harvested as useful light. Furthermore, it would be difficult to attain desirable CIE coordinates and CRI values for white OLED devices together with high efficiencies because the longer wavelengths from the highly efficient phosphorescent emitters would dominate the blue emission from the fluorescent emitter.

As discussed above, it is desired to combine fluorescent and phosphorescent emitters in multicolor (e.g. white) OLEDs, especially using a blue fluorescent emitter since stable blue phosphorescent emitters are not known at present. In order to achieve highest possible internal quantum efficiency, device structures are sought in which singlet excitons are harvested by the fluorescent emitter, while the triplet excitons are harvested by the phosphorescent emitter(s). One strategy to accomplish this can be to have the recombination to occur in a fluorescent emissive layer where the singlet excitons are captured by the fluorescent emitter, while the triplet excitons diffuse to another area where they may be harvested by phosphorescent emitters. In order that the triplet excitons be free to diffuse out of the fluorescent emissive layer, they must not be deeply trapped by any fluorescent dopant present, among other requirements.

Co-filed Attorney Docket No. 93237AEK discloses hybrid devices in which the triplet energy of the fluorescent emitter is not more than 0.2 eV below that of the host material in the fluorescent emissive layer, and preferably about equal or greater, so that triplet excitons would not be deeply trapped on the fluorescent dopant where they would eventually decay non-radiatively. However, this places severe limitations on choice of fluorescent dopant molecules that have a high enough triplet energy to be compatible, for example, with a green phosphorescent emissive layer, yet still have high fluorescence emission quantum yield.

Recently, Y. Sun et al (Nature, 440, 908-912 (2006)) have proposed that hybrid fluorescent/phosphorescent white OLEDs could potentially convert all of the electron-hole recombination into light emission if the triplet states formed in the fluorescent emissive layer could diffuse to a layer comprising the phosphorescent emitter(s) where they could be captured and emit light. Sun et al employed a blue fluorescent emitter in a host material. However, the triplet energy level of the blue fluorescent emitter in Sun et al was well below that of the host material used for the phosphorescent emitter. Therefore, it is possible that a significant amount of the triplet excitons could become trapped on the fluorescent emitter where they would decay non-radiatively.

Pfeiffer et al (WO2006097064) attempt to achieve high efficiency with devices that comprise fluorescent blue emitters that have triplet energies greater than that of the phosphorescent emitter(s) in order that transfer of triplet excitons from the fluorescent emitter to the phosphorescent emitter will be energetically favorable. However, if the triplet energy of the fluorescent emitter is not also greater than the triplet energy of the phosphorescent host material, the diffusion of triplets into the phosphorescent layer will not easily be able to diffuse further than the phosphorescent emitters at the interface between the two layers. This is because these emitters are dilute with respect to the host and the diffusion of triplet excitons requires close contact of molecules for molecule to molecule transfer (often referred to as Dexter transfer, see A. Lamola and N. Turro, ‘Energy Transfer and Organic Photochemistry’, Technique of Organic Chemistry, Vol. XIV, Interscience Publishers, 1969). In Pfeiffer et al, the fluorescent emitters disclosed were single component materials.

Y. J. Tung et al, US App 2006/0232194 A1 discloses white OLED devices with a fluorescent blue emitting material as a dopant in a host material and a second emissive layer comprising a phosphorescent emitting material as a dopant in a host material. There may be a spacer layer between the two emissive layers.

Nagara et al, US App 2006/0125380 A1 describes organic EL devices with a fluorescent light emitting layer nearer to the cathode, a non-light emitting interface layer, and a phosphorescent light emitting layer.

Tung et al, US App 2007/0075631 A1 describes organic EL devices with an electron impeding layer between a light emissive layer and an electron transport layer where a certain relationship between the HOMO of the emissive host and the emissive dopant is defined.

Forrest et al, US App 2006/0251921 A1 describes organic EL devices with a phosphorescent emissive layer and an adjacent transport layer where the host, dopant and transport materials have defined HOMO, LUMO and triplet energy relationships.

However, all these disclosures show limited efficiency of blue light output, which limits the overall efficiency of white devices since the green and red components of the white emission must be balanced with the blue component in order to achieve desirable CIE coordinates and CRI.

OLEDs producing a white emission are of interest for solid-state lighting applications, backlights for LCDs, and OLED displays incorporating color filters.

Notwithstanding all these developments, there remains a need to further improve efficiency of OLED devices.

### SUMMARY OF THE INVENTION

This invention provides an OLED device comprising:

a) a fluorescent light emitting layer comprising a fluorescent emitter and a fluorescent host material wherein the HOMO energy level of the fluorescent host material is not more than 0.1 eV more negative than that of the fluorescent emitter;

b) a phosphorescent light emitting layer comprising a phosphorescent emitter and a phosphorescent host material;

c) a spacer layer interposed between the fluorescent light emitting layer and the phosphorescent light emitting layer; and

wherein the triplet energy of the fluorescent host material is not more than 0.2 eV less than the triplet energy of both the spacer layer material and of the phosphorescent host material.

Another embodiment provides an exciton blocking layer adjacent to the fluorescent LEL on the opposite side of the fluorescent LEL from the spacer layer and phosphorescent LEL wherein the exciton blocking layer material has a triplet energy greater than that of the fluorescent host material by at least 0.15 eV.

Additional embodiments include where the hybrid light emitting units of the invention include an additional light emitting unit to form a stacked OLED device.

The devices of the invention exhibit improved efficiency.

### BRIEF DESCRIPTION OF THE DRAWINGS

FIG. 1 shows a schematic cross-section of one embodiment of an OLED device in which this invention can be used. It will be understood that FIG. 1 is not to scale since the individual layers are too thin and the thickness differences of various layers are too great to permit depiction to scale.

### DETAILED DESCRIPTION OF THE INVENTION

The electroluminescent device is summarized above. The device can also include a hole injecting layer, a hole transporting layer, a hole blocking layer, an electron transporting layer, or more than one of these optional layers.

In the following discussion, it should be understood that a fluorescent emissive layer refers to any light emitting layer which contains a material that emits light via a singlet excited state, a phosphorescent emissive layer refers to any light emitting layer which contains a material that emits light via a triplet excited state, a host is a non or weakly light emitting material under operating conditions that is the main component of a light emitting layer, a hybrid OLED device is one that contains at least one fluorescent emissive layer and at least one phosphorescent emissive layer, and a stacked (also referred to as tandem or cascaded) OLED device is one in which there are at least two separate light emitting regions in a vertical direction, separated by an electrically conductive, but non-light emitting region. By referring to anode side, it is meant that side of the layer that is closest to the anode. By referring to cathode side, it is meant that side of the layer that is closest to the cathode.

The present invention requires that the HOMO energy level of the fluorescent host is not more than 0.1 eV more negative than that of the fluorescent emitter. For example, if the HOMO energy level of the fluorescent host is −5.6 eV, then the HOMO energy level of the fluorescent emitter should be −5.5 or more negative. It is preferred that the HOMO energy level of the fluorescent host be equal to or less negative than the fluorescent emitter. There may be more than one fluorescent host present in the layer as well as more than one fluorescent emitter.

When the HOMO (Highest Occupied Molecular Orbital) energy level of the fluorescent emitter is not more than 0.1 eV more negative than that of the host material, such materials do not appear to trap the majority of the triplet excitons even if they have a triplet energy more than 0.2 eV less than that of the host material. Without being limited by a particular theory, it is believed that such emitters do not trap holes deeply and subsequently recombine with electrons, and thus, the triplet excitons are not formed on the emitters but instead, remain on the host molecules with little chance of being trapped by the emitters, especially when present at low concentrations (about 1%). While it may be energetically favorable for such emitters to trap electrons in some cases, it is thought that this is not a frequent occurrence when holes are the dominant charge carrier in the host material and that recombination occurs more rapidly on the host molecules. On the other hand, fluorescent emitting molecules that have a HOMO level greater than that of the host material, may readily trap holes and subsequently recombine with electrons. In this case, recombination occurs directly on the emitter molecule and resulting in triplet excitons deeply trapped on the emitter molecule when its triplet energy is less than that of the host. In this case, the efficiency of the OLED device is not increased.

In order to ensure efficient transfer of triplet energy from the fluorescent layer to the phosphorescent layer, the present invention further requires that the triplet energy of the fluorescent host is not more than 0.2 eV less than the triplet energy of both the spacer layer material and of the phosphorescent host material. For example, if the triplet energy of the host for the fluorescent layer is 2.7 eV, the triplet energy of the material in the spacer layer must be 2.9 eV or less and triplet energy of the phosphorescent host must be 2.9 eV or less. It is possible for thermal equilibrium to allow significant transfer of triplets from the fluorescent host to the spacer or phosphorescent host if the triplet energy of the fluorescent host is up to 0.2 eV below that of the spacer or phosphorescent host. It is preferred that the triplet energy of the fluorescent host is greater than or equal to that of the spacer and phosphorescent host materials.

To produce a white emitting device, ideally the hybrid fluorescent/phosphorescent device would comprise a blue fluorescent emitter and proper proportions of a green and red phosphorescent emitter, or other color combinations suitable to make white emission. However, hybrid devices having non-white emission may also be useful by themselves. Hybrid fluorescent/phosphorescent elements having non-white emission may also be combined with additional phosphorescent elements in series in a stacked OLED. For example, white emission may be produced by one or more hybrid blue fluorescent/red phosphorescent elements stacked in series with a green phosphorescent element using p/n junction connectors as disclosed in Tang et al, U.S. Pat. No. 6,936,961B2.

The present invention overcomes the limitations of known devices by providing hybrid fluorescent/phosphorescent OLED devices that produce a fluorescent emission component with high efficiency while simultaneously allowing diffusion of triplet excitons from a singlet emissive region to the phosphorescent emissive regions. This is enabled by the indicated energy relationship of the HOMO of the fluorescent emitter and host molecules as well as the triplet energy relationships between the fluorescent host and materials in a non-emitting spacer layer and the phosphorescent layer.

In the most desirable embodiments, the fluorescent layer emits blue light while the phosphorescent layer emits either red or green light. In examples where there are more than one phosphorescent layer present, both may emit green light, both may emit red light or one can emit green light and the other red light.

According to the present invention the triplet energy of the fluorescent host is not more than 0.2 eV less than the triplet energy of both the spacer layer material disposed between the fluorescent emissive layer and the phosphorescent emissive layer. Such a spacer is necessary in order that singlet excitons on the fluorescent emitter are emitted as light rather than be transferred to the phosphorescent emitter. The mechanism of transfer of singlet excitons does not require molecular contact but involves a thru-space coupling known as Förster transfer (see J. Birks, “Photophysics of Aromatic Molecules”, Wiley-Interscience, 1970), the magnitude of which depends inversely on distance to the sixth power. Thus, the spacer material properties and thickness need to be chosen so as to allow Dexter transfer of triplet excitons from the fluorescent emitter to the phosphorescent layer but allow only a small amount of Förster transfer of singlet excitons. This is especially important in hybrid devices where it is necessary to maximize the amount of blue light produced by fluorescence in order to achieve balanced white emission while achieving high overall efficiency.

Another important property of the spacer and host materials is that phosphorescent lifetimes be long (i.e. non-radiative decay rates should be small) in order that the triplet exciton diffusion lengths are long. For example, the triplet exciton diffusion length in Alq₃ was estimated to be (140±90) Å in Baldo et al, Phys. Rev. B, 62, 10958-10966 (2000). Clearly, in order to construct the most efficient hybrid fluorescent/phosphorescent devices with high blue component for desirable CIE coordinates and CRI values, the host and spacer materials, especially the fluorescent host and spacer materials, should be selected to have triplet exciton diffusion lengths that are long in comparison with the Förster transfer radius for the fluorescent emitter to other materials, including the phosphorescent emitter.

For many applications, such as white OLEDs, in order to achieve desirable CIE coordinates and CRI values while achieving maximum efficiency, it is necessary to maximize the efficiency of blue emission provided by a fluorescent emitter in order to have enough blue component in the overall device emission when the longer wavelength components are provided by efficient phosphorescent emissive layers. In addition to preferably employing a fluorescent emitter in combination with a host, it is desirable to select and arrange the various materials and layers in a device in order to have all or nearly all of the electron and hole recombination occur in proximity to the blue fluorescent emitter so that all or nearly all of the singlet excitons are converted into blue light emission. One way to achieve this is to arrange layers and materials such that recombination occurs near the interface of the blue fluorescent layer with a spacer layer interposed between the fluorescent layer and the phosphorescent layer, or near the interface of the fluorescent layer and adjacent charge transporting layer. Host and spacer materials can be dominantly electron transporting or dominantly hole transporting. Recombination will generally occur at or near an interface of a material that is dominantly hole transporting with a material that is dominantly electron transporting, especially if the LUMO of the hole transporting material is at least about 0.2 eV above that of the electron transporting material, and the HOMO of the electron transporting material is at least about 0.2 eV below that of the hole transporting material so as to present energy barriers to the charge carriers crossing the interface independent of recombination.

There are thus several arrangements then of host and spacer materials that would lead to recombination occurring dominantly at or near one of the interfaces of the fluorescent emissive layer:
(a) In a preferred arrangement, the fluorescent emissive layer host, the spacer layer material, and the phosphorescent emissive layer host are each electron-transporting and the fluorescent emissive layer contacts a separate hole transport layer on the anode side while the spacer material and phosphorescent emissive layer are deposited on the cathode side of the fluorescent emissive layer.
(b) In another embodiment, the fluorescent emissive layer host, the spacer layer material, and the phosphorescent emissive layer host are each hole transporting and the fluorescent emissive layer contacts an electron transport material on the cathode side and on the opposite side of the spacer layer while the spacer layer and phosphorescent emissive layer are deposited on the anode side of the fluorescent emissive layer.
(c) In another embodiment, the fluorescent emissive layer host is electron transporting while the spacer layer material and the phosphorescent emissive layer host are each hole transporting and deposited on the anode side of the fluorescent emissive layer.
(d) In another embodiment, the fluorescent emissive layer host is hole transporting while the spacer layer material and the phosphorescent emissive layer host are each electron transporting and deposited on the cathode side of the fluorescent emissive layer.

Further extensions of these arrangements are contemplated in which there is a phosphorescent emissive layer and spacer layer on each side of the fluorescent emissive layer in a phosphorescent layer, spacer layer, fluorescent layer, spacer layer, phosphorescent layer arrangement. It is preferred that these layers be in direct contact or sequence with each other without any intermediate layers in between them. It would also be preferred that the fluorescent emissive layer emits primarily blue light while the phosphorescent emissive layers emits primarily red light. Alternatively, the phosphorescent layer(s) could emit primarily green and red light.

Another embodiment would be as in (c) above but having a second phosphorescent emissive layer and spacer layer deposited on the cathode side of the fluorescent emissive layer. In this embodiment, the second phosphorescent layer host material and second spacer material would be electron transporting. Another embodiment would be as in (d) above but having a second phosphorescent emissive layer and spacer layer deposited on the anode side of the fluorescent emissive layer. In this embodiment, the second phosphorescent layer host material and second spacer material would be hole transporting.

It is further contemplated that the phosphorescent emissive layers in the present invention may comprise more than one emitter in order to achieve desired CIE coordinates and CRI values. The phosphorescent emitters may be co-doped in the same region of the emissive layer, or may be separated into different sublayers. The phosphorescent emissive layers may also comprise more than one host. If more than one phosphorescent host material is used, these may be mixed in the same region or separated into different sublayers. For instance, there could be a sublayer comprising a green phosphorescent emitter in one host, followed by a sublayer comprising a red phosphorescent emitter in a second host. In the case where a second phosphorescent host has a lower triplet energy than the first phosphorescent host, it is preferred that the layer having the higher triplet energy host be placed closest to the spacer layer and the fluorescent emissive layer.

In order that the triplet excitons diffuse from the fluorescent emissive layer toward only the spacer and phosphorescent emissive layer, further preferred embodiments of the invention include an exciton blocking layer. This layer comprises any hole or electron transporting material that is in contact with the fluorescent emissive layer on the opposite side of the said fluorescent emissive layer from the spacer layer and phosphorescent layer should have a triplet energy at least 0.2 eV above that of the fluorescent host material. It is further desirable to limit diffusion of triplet excitons past the phosphorescent emissive layer(s) by requiring that any hole or electron transport materials deposited on the side of the phosphorescent emissive layer host opposite from the spacer layer have a triplet energy at least 0.2 eV above that of said phosphorescent emissive layer host.

In order to maximize the blue fluorescent component of the emission, there are further preferred embodiments in which a first hole transporting material is deposited on the anode, followed by an exciton blocking layer containing a second hole transporting material, followed by a fluorescent emissive layer having electron transporting properties, wherein the second hole transport (exciton blocking) material has a HOMO (Highest Occupied Molecular Orbital) at least 0.2 eV below that of the first hole transporting material while its LUMO (Lowest Unoccupied Molecular Orbital) is at least 0.2 eV above that of the electron transporting fluorescent emissive layer host. It is preferred that said It second hole transport material be disposed between the first hole transport material and the blue fluorescent emissive layer with electron transporting host, but in other embodiments the second hole transport material layer having the lower HOMO level may be placed before the first hole transport material or anywhere within the first hole transport material. In still further embodiments, there may be more than two hole transport material layers and/or there may be hole injection material layers present.

### HOMO/LUMO Energy Levels

HOMO and LUMO energies for any compound can be either experimentally determined using many types of well-known known techniques (see, for examples, U.S. Pat. No. 7,132,174B2, U.S. Pat. No. 7,128,982B2, US App 2006/0246315 or U.S. Pat. No. 7,045,952B2) or can be calculated. If possible, the HOMO and LUMO energies of a compound should be experimentally determined for this invention. The HOMO and LUMO energy data shown in the Tables for specific compounds were all experimental determined using the cyclic voltammetry method unless otherwise noted.

However, if the energies cannot be measured, the calculated values may be used. The calculated HOMO and LUMO energies for a molecule can be derived from the raw orbital energies of Density Functional Theory calculations given in eV. These raw HOMO and LUMO orbital energies (E_{Hraw} and E_{Lraw} respectively) are modified by empirically derived constants whose values were obtained by comparing the computed raw energies to experimental orbital energies obtained from electrochemical data, so that the HOMO and LUMO energies are given by equations 1 and 2:

HOMO=0.643*(E_{Hraw})−2.13 (eq. 1)

LUMO=0.827*(E_{Lraw})−1.09 (eq. 2)

E_{Hraw} is the energy of the highest-energy occupied molecular orbital, and E_{Lraw} is the energy of the lowest-energy unoccupied molecular orbital, both values expressed in eV. Values of E_{Hraw} and E_{Lraw} are obtained using the B3LYP method as implemented in the Gaussian 98 (Gaussian, Inc., Pittsburgh, (Pa.) computer program. The basis set for use with the B3LYP method is defined as follows: MIDI! for all atoms for which MIDI! is defined, 6-31 G* for all atoms defined in 6-31 G* but not in MIDI!, and either the LACV3P or the LANL2DZ basis set and pseudopotential for atoms not defined in MIDI! or 6-31 G*, with LACV3P being the preferred method. For any remaining atoms, any published basis set and pseudopotential may be used. MIDI!, 6-31 G* and LANL2DZ are used as implemented in the Gaussian98 computer code and LACV3P is used as implemented in the Jaguar 4.1 (Schrodinger, Inc., Portland Oreg.) computer code. For polymeric or oligomeric materials, it is sufficient to compute E_{Hraw} and E_{Lraw} over a monomer or oligomer of sufficient size so that additional units do not substantially change the values of E_{Hraw} and E_{Lraw}. It should be noted that the calculated energy values may typically show some deviation from the experimental values.

Because the molecular orbitals energies cannot be either calculated or measured accurately in some situations, differences of less than 0.05 should be considered equal for the purposes of this invention.

### Triplet Energy

Triplet energy can be measured by any of several means, as discussed for instance in S. L. Murov, I. Carmichael, and G. L. Hug, Handbook of Photochemistry, 2nd ed. (Marcel Dekker, New York, 1993). However, direct measurement can often be difficult to accomplish.

For simplicity and convenience, the triplet state of a compound should be calculated for this invention even though the calculated values for the triplet state energy of a given compound may typically show some deviation from the experimental values. If calculated triplet energy values are unavailable, then experimentally determined values can be used. Because the triplet energies cannot be either calculated or measured accurately in some situations, differences of less than 0.05 should be considered equal for the purposes of this invention.

The calculated triplet state energy for a molelcule is derived from the difference between the ground state energy (E(gs)) of the molecule and the energy of the lowest triplet state (E(ts)) of the molecule, both given in eV. This difference is modified by empirically derived constants whose values were obtained by comparing the result of E(ts)−E(gs) to experimental triplet energies, so that the triplet state energy is given by equation 1:

E(t)=0.84*(E(ts)−E(gs))+0.35 (eq. 1)

Values of E(gs) and E(ts) are obtained using the B3LYP method as implemented in the Gaussian 98 (Gaussian, Inc., Pittsburgh, Pa.) computer program. The basis set for use with the B3LYP method is defined as follows: MIDI! for all atoms for which MIDI! is defined, 6-31 G* for all atoms defined in 6-31 G* but not in MIDI!, and either the LACV3P or the LANL2DZ basis set and pseudopotential for atoms not defined in MIDI! or 6-31 G*, with LACV3P being the preferred method. For any remaining atoms, any published basis set and pseudopotential may be used. MIDI!, 6-31 G* and LANL2DZ are used as implemented in the Gaussian98 computer code and LACV3P is used as implemented in the Jaguar 4.1 (Schrodinger, Inc., Portland Oreg.) computer code. The energy of each state is computed at the minimum-energy geometry for that state

For polymeric or oligomeric materials, it is sufficient to compute the triplet energy over a monomer or oligomer of sufficient size so that additional units do not substantially change the computed triplet energy.

### Fluorescent Light Emitting Layers 109

One critical feature of the present invention is the selection of blue fluorescent host and emitter combinations based on their relative HOMO energies that enable energetically favorable transfer of triplet excitons to a phosphorescent host and emitter. Most of the commonly used blue fluorescent emitters that give high quantum yields generally have triplet energies about 2 eV or less. However, some are higher. Preferred fluorescent emitters have a triplet energy of 2.0 eV or greater or most preferably 2.2 eV or greater. For example, the fluorescent emitter Emitter-1 (Difluoro[6-mesityl-N-(2(1H)-quinolinylidene-κN)-(6-mesityl-2-quinolinaminato-κN1)]boron) has a triplet energy of 2.29 eV by DFT calculation and is particularly preferred for this invention.

Although the term “fluorescent” is commonly used to describe any light emitting material, in this case, it is a material that emits light from a singlet excited state. Although in this invention, fluorescent materials may not be used in the same layer as the phosphorescent material, they may be used together in other (non-inventive) LELs, or in adjacent layers, in adjacent pixels, or any combination. Care must be taken not to select materials that will adversely affect the performance of the phosphorescent materials of this invention. One skilled in the art will understand that concentrations and triplet energies of materials in the same layer as the phosphorescent material or in an adjacent layer must be appropriately set so as to prevent unwanted quenching of the phosphorescence.

As more fully described in U.S. Pat. Nos. 4,769,292 and 5,935,721, a light emitting layer (LEL) of the organic EL element includes a luminescent fluorescent or phosphorescent material where electroluminescence is produced as a result of electron-hole pair recombination. The light emitting layer can be comprised of a single material, but more commonly consists of a host material doped with a guest emitting material and can be of any color. The host materials in the light emitting layer can be an electron transporting material, as defined below, a hole transporting material, as defined below, or another material or combination of materials that support hole-electron recombination. Fluorescent emitting materials are typically incorporated at 0.01 to 10% by weight of the host material.

The host and emitting materials can be small non-polymeric molecules or polymeric materials such as polyfluorenes and polyvinylarylenes (e.g., poly(p-phenylenevinylene), PPV). In the case of polymers, small-molecule emitting materials can be molecularly dispersed into a polymeric host, or the emitting materials can be added by copolymerizing a minor constituent into a host polymer. Host materials may be mixed together in order to improve film formation, electrical properties, light emission efficiency, operating lifetime, or manufacturability. The host may comprise a material that has good hole transporting properties and a material that has good electron transporting properties.

It is highly desirable that the excited singlet-state energy of the fluorescent material be lower than that of the host material. The excited singlet-state energy is defined as the difference in energy between the emitting singlet state and the ground state.

Host and emitting materials known to be of use include, but are not limited to, those disclosed in U.S. Pat. No. 4,768,292, U.S. Pat. No. 5,141,671, U.S. Pat. No. 5,150,006, U.S. Pat. No. 5,151 629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,928,802, U.S. Pat. No. 5,935,720, U.S. Pat. No. 5,935,721, and U.S. Pat. No. 6,020,078.

Some fluorescent emitting materials include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrylium and thiapyrylium compounds, fluorene derivatives, fluoranthenes derivatives, periflanthene derivatives, indenoperylene derivatives, bis(azinyl)amine boron compounds, bis(azinyl)methane compounds, and carbostyryl compounds. Illustrative examples of useful materials include, but are not limited to, the following:

| | |
|---|---|
| 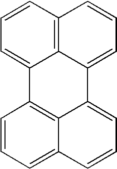 | 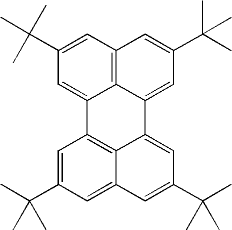 |
| L1 | L2 |

| | |
|---|---|
| 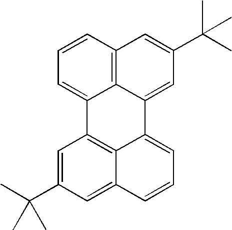 | 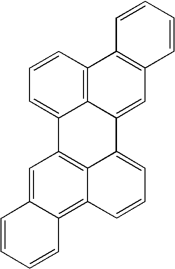 |
| L3 | L4 |

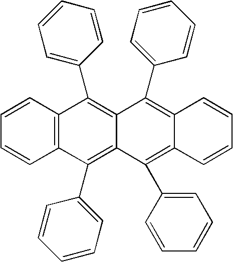

L5

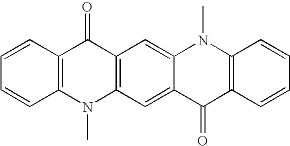

L6

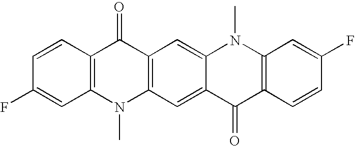

L7

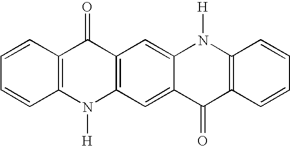

L8

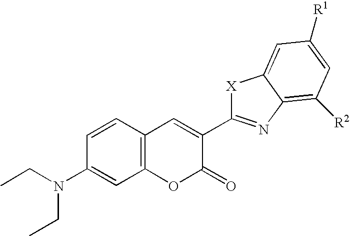

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |

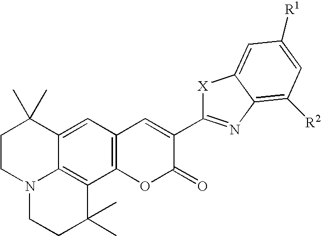

| | X | R1 | R2 |
|---|---|---|---|
| L23 | O | H | H |
| L24 | O | H | Methyl |
| L25 | O | Methyl | H |
| L26 | O | Methyl | Methyl |
| L27 | O | H | t-butyl |
| L28 | O | t-butyl | H |
| L29 | O | t-butyl | t-butyl |
| L30 | S | H | H |
| L31 | S | H | Methyl |
| L32 | S | Methyl | H |
| L33 | S | Methyl | Methyl |
| L34 | S | H | t-butyl |
| L35 | S | t-butyl | H |
| L36 | S | t-butyl | t-butyl |

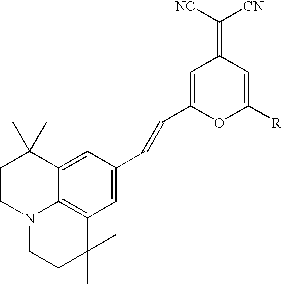

| | R |
|---|---|
| L37 | phenyl |
| L38 | methyl |
| L39 | t-butyl |
| L40 | mesityl |

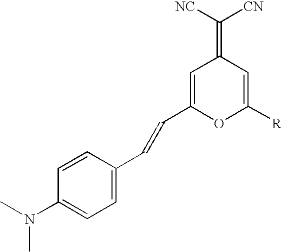

| | R |
|---|---|
| L41 | phenyl |
| L42 | methyl |
| L43 | t-butyl |
| L44 | mesityl |

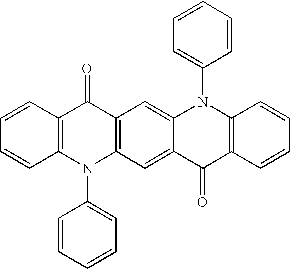

L45

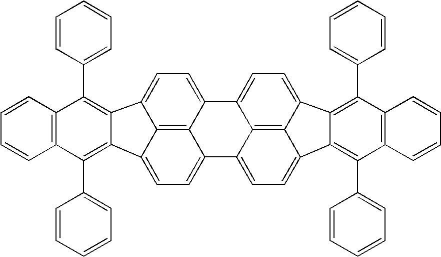

L46

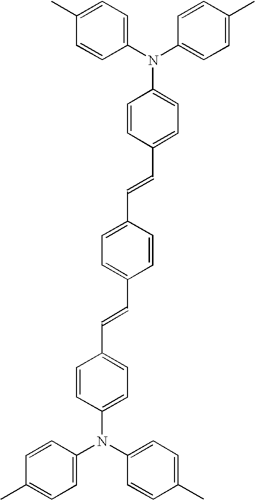

L47

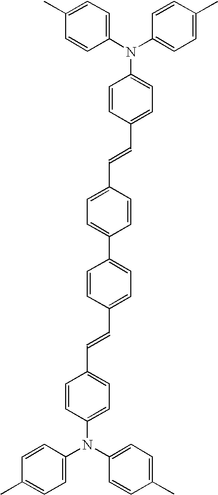

L48

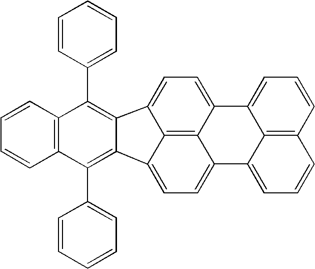

L49

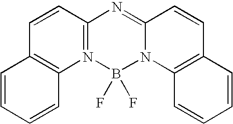

L50

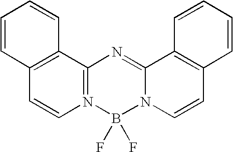

L51

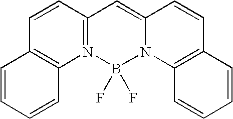

L52

Of these, the most preferred blue fluorescent emitters would have a HOMO energy level more negative than −5.1 or more preferable more negative than −5.35 or most preferable, more negative than −5.6. It would be also desirable that the fluorescent emitter also have a triplet energy of at least 2.2 eV or greater. In particular, bis(azinyl)amine boron compounds are very suitable for use as a blue emitter in this invention. Emitter-1 is particularly preferred.

The following table lists the energy levels of some representative structures of fluorescent emitters suitable for this invention. HOMO and LUMO energies were calculated as well known in the art. In this and all subsequent tables, energy levels (triplet energy, LUMO and HOMO) are expressed in units of eV.

Energy Levels for Specific Fluorescent Emitters

| | HOMO | LUMO | Triplet | |
|---|---|---|---|---|
| Identifier | Energy | Energy | Energy | Structure |
| Emitter-1 | −5.69 | −2.77 | 2.29 | 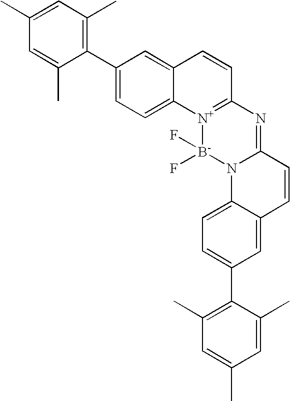 |
| Emitter-2 | −5.09 | −2.23 | 1.98 | 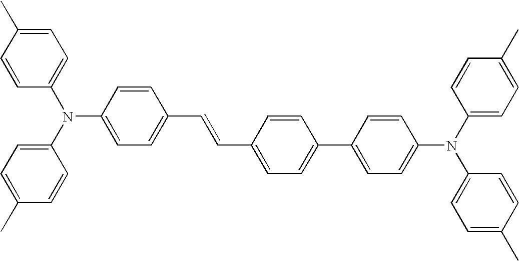 |
| Emitter-3(L47) | −5.04 | −2.41 | 1.82 | 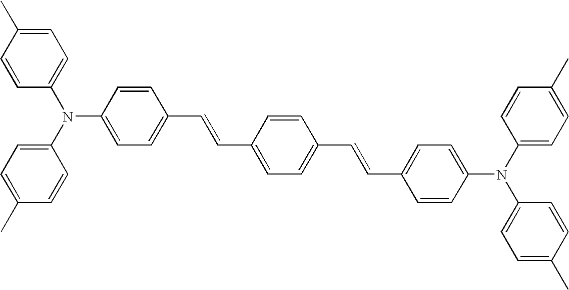 |
| Emitter-4(BCZVBI) | −5.24 | −2.30 | 2.08 | 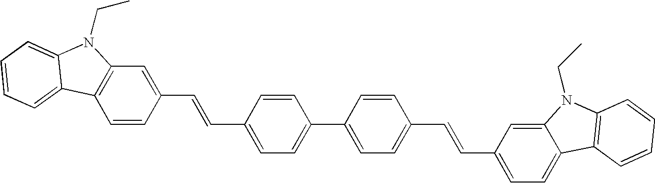 |
| Emitter-5(BCZVB) | −5.17 | −2.28 | 1.92 | 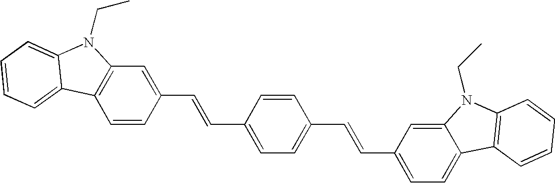 |
| Emitter-6(TBP)(L2) | −5.24 | −2.54 | 1.67 | 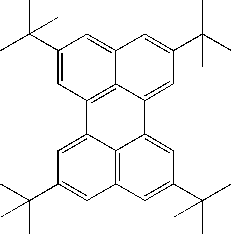 |
| Emitter-7(DPVBI) | −5.53 | −2.42 | 1.81 | 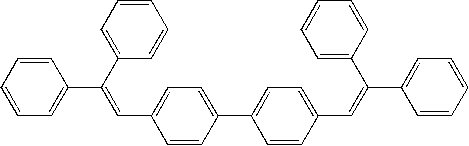 |
| Emitter-8(L23) | −5.51 | −2.70 | 2.03 | 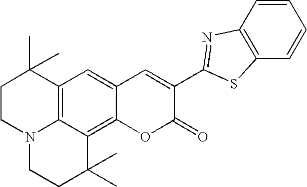 |
| Emitter-9(L45) | −5.40 | −2.60 | 2.14 | 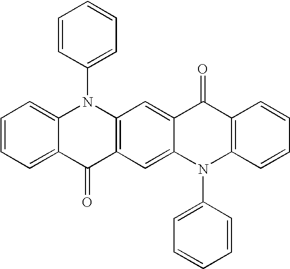 |
| Emitter-10(L39) | −5.49 | −2.97 | 1.82 | 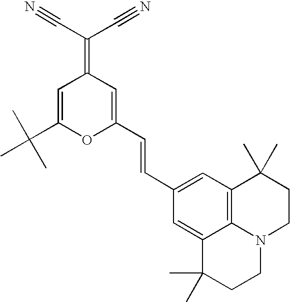 |
| Emitter-11(L46) | −5.23 | −3.09 | 1.41 | 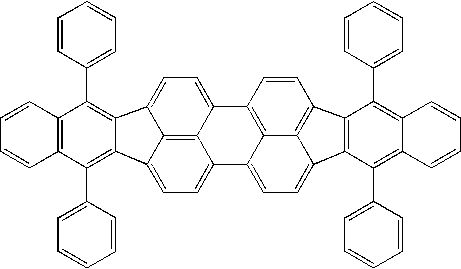 |
| Emitter-12 | −5.41 | −2.60 | 1.90 | 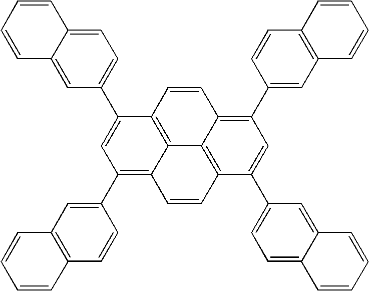 |
| Emitter-13(perylene)(L1) | −5.38(−5.38) | −2.69(−2.64) | 1.67 | 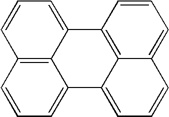 |
| Emitter-14(Host-3)(BPHFL) | −5.74 | −2.57 | 2.29 | 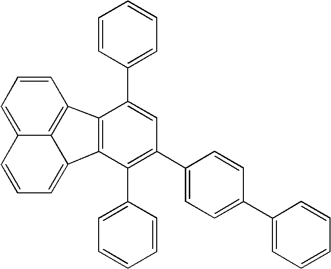 |

It should be noted that some materials can be used either as an emissive material or dopant, but in other formats, used as a host for another emitter. Whether a certain material behaves as either a host or an emitter depends on what other materials may be present in the same or adjacent layers. For example, many anthracene derivatives give fluorescent emission when used alone or in combination with certain types of host materials in a LEL, yet the same material can be a non-emissive host if used with the proper kind of emitter.

Many different types of materials are suitable for a fluorescent host and depends on what is selected as the fluorescent emitter. Suitably, the host has a HOMO energy level of −5.7 or less negative, or more preferably, between −5.2 and −5.7, or most preferable, between −5.2 and −5.5. It would be also desirable that the fluorescent host also has a triplet energy of at least 2.2 eV or greater and not more than 0.2 eV greater than that of the fluorescent emitter.

Metal complexes of 8-hydroxyquinoline and similar derivatives, also known as metal-chelated oxinoid compounds (formula (MCOH-a), constitute one class of useful host compounds capable of supporting electroluminescence, and are particularly suitable for light emission of wavelengths longer than 500 nm, e.g., green, yellow, orange, and red.

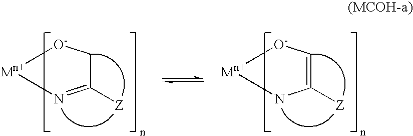

wherein

M represents a metal;

n is an integer of from 1 to 4; and

Z independently in each occurrence represents the atoms completing a nucleus having at least two fused aromatic rings.

From the foregoing it is apparent that the metal can be monovalent, divalent, trivalent, or tetravalent metal. The metal can, for example, be an alkali metal, such as lithium, sodium, or potassium; an alkaline earth metal, such as magnesium or calcium; a trivalent metal, such aluminum or gallium, or another metal such as zinc or zirconium. Generally any monovalent, divalent, trivalent, or tetravalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
MCOH-1: Aluminum trisoxine[alias, tris(8-quinolinolato)aluminum(III)]
MCOH-2: Magnesium bisoxine[alias, bis(8-quinolinolato)magnesium(II)]
MCOH-3: Bis[benzo{f}-8-quinolinolato]zinc(II)
MCOH-4: Bis(2-methyl-8-quinolinolato)aluminum(III)-μ-oxo-bis(2-methyl-8-quinolinolato)aluminum(III)
MCOH-5: Indium trisoxine[alias, tris(8-quinolinolato)indium]
MCOH-6: Aluminum tris(5-methyloxine)[alias, tris(5-methyl-8-quinolinolato)aluminum(III)]
MCOH-7: Lithium oxine[alias, (8-quinolinolato)lithium(I)]
MCOH-8: Gallium oxine[alias, tris(8-quinolinolato)gallium(III)]
MCOH-9: Zirconium oxine[alias, tetra(8-quinolinolato)zirconium(IV)]

Particularly useful aluminum or gallium complex host materials are represented by Formula (MCOH-b).

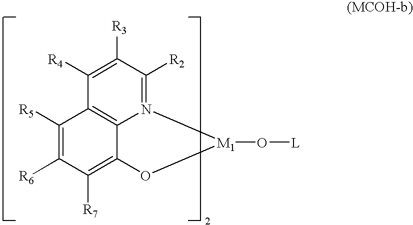

In Formula (MCOH-b), M₁ represents Al or Ga. R₂-R₇ represent hydrogen or an independently selected substituent. Desirably, R₂ represents an electron-donating group, such as a methyl group. Suitably, R₃ and R₄ each independently represent hydrogen or an electron donating substituent. Preferably, R₅, R₆, and R₇ each independently represent hydrogen or an electron-accepting group. Adjacent substituents, R₂-R₇, may combine to form a ring group. L is an aromatic moiety linked to the aluminum by oxygen, which may be substituted with substituent groups such that L has from 6 to 30 carbon atoms. Besides, Host-1, Host-2 and Host-4 (Balq), other illustrative examples of Formula (MCOH-b) materials are listed below.

| | |
|---|---|
| MCOH-10 | 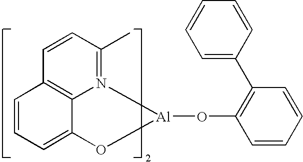 |
| MCOH-11 | 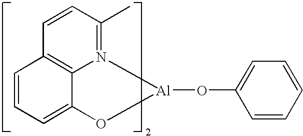 |
| MCOH-12 | 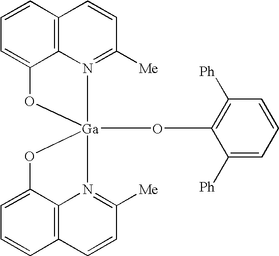 |
| MCOH-13 | 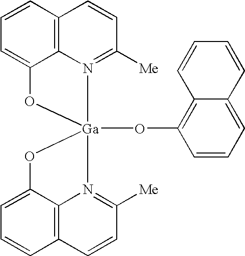 |

Derivatives of 9,10-di-(2-naphthyl)anthracene (formula (DNAH)) constitute one class of potential host materials capable of supporting fluorescent electroluminescence, and are particularly suitable for light emission of wavelengths longer than 400 nm, e.g., blue, green, yellow, orange or red.

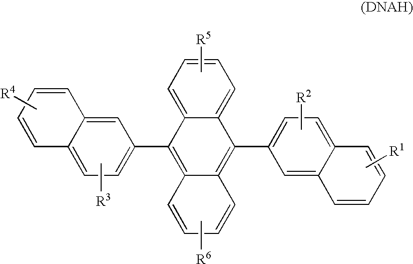

wherein R¹, R², R³, R⁴, R⁵, and R⁶ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of anthracenyl; pyrenyl, or perylenyl;

Group 4: heteroaryl or substituted heteroaryl of from 5 to 24 carbon atoms as necessary to complete a fused heteroaromatic ring of furyl, thienyl, pyridyl, quinolinyl or other heterocyclic systems;

Group 5: alkoxylamino, alkylamino, or arylamino of from 1 to 24 carbon atoms; and

Group 6: fluorine, chlorine, bromine or cyano.

Illustrative examples include 9,10-di-(2-naphthyl)anthracene, 2-t-butyl-9,10-di-(2-naphthyl)anthracene (Host-5), 9-(1-naphthyl)-10-(2-naphthyl)anthracene and 2-phenyl-9,10-di-(2-napthyl)anthracene. Other anthracene derivatives can be useful as a host in the LEL, including derivatives of 9,10-bis[4-(2,2-diphenylethenyl)phenyl]anthracene.

Benzazole derivatives (formula (BAH)) constitute another class of useful host materials capable of supporting fluorescent electroluminescence, and are particularly suitable for light emission of wavelengths longer than 400 nm, e.g., blue, green, yellow, orange or red:

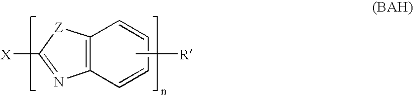

where:

n is an integer of 3 to 8;

Z is O, NR or S; and

R and R′ are individually hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and

X is a linkage unit consisting of carbon, alkyl, aryl, substituted alkyl, or substituted aryl, which connects the multiple benzazoles together. X may be either conjugated with the multiple benzazoles or not in conjugation with them. An example of a useful benzazole is 2,2′,2″-(1,3,5-phenylene)tris[1-phenyl-1H-benzimidazole] (TPBI).

Styrylarylene derivatives as described in U.S. Pat. No. 5,121,029 and JP 08333569 are also hosts for blue emission. For example, 9,10-bis[4-(2,2-diphenylethenyl)phenyl]anthracene and 4,4′-bis(2,2-diphenylethenyl)-1,1′-biphenyl (DPVBi) could be hosts for blue emission.

Fluoranthene derivatives as described in WO2005026088, WO2005033051, US App 2006/141287, EP1719748, JP2003238516, JP2005320286, US App 2004/0076853, U.S. Pat. No. 6,929,871, US App 2005/02711899 and US App 2002/022151 are also useful hosts. These materials have a structure according to formula (FAH):

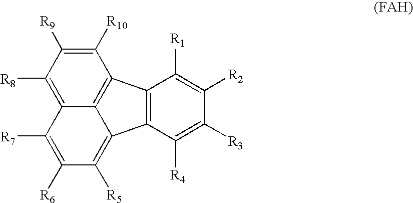

wherein R₁-R₁₀ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused or annulated aromatic ring such as benzene, napthyl, anthracenyl; pyrenyl, or perylenyl;

Group 4: heteroaryl or substituted heteroaryl of from 5 to 24 carbon atoms as necessary to complete a fused heteroaromatic ring such as furyl, thienyl, pyridyl, quinolinyl or other heterocyclic systems;

Group 5: alkoxylamino, alkylamino, or arylamino of from 1 to 24 carbon atoms; and

Group 6: fluorine, chlorine, bromine or cyano.

Of these substituents, those of groups 1 and 2 are preferred. For Group 3, benzene and napthyl are preferred. A representative example of this class of materials is BPHFL (Host-3).

Yet another class of useful host materials are fluorene derivatives according to formula (SFH):

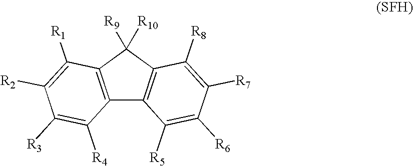

wherein R₁-R₁₀ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused or annulated aromatic ring such as benzene, napthyl, anthracenyl; pyrenyl, or perylenyl, also including an additional fused fluorene to form a bis-spirofluorene;

Group 4: heteroaryl or substituted heteroaryl of from 5 to 24 carbon atoms as necessary to complete a fused heteroaromatic ring such as furyl, thienyl, pyridyl, quinolinyl or other heterocyclic systems;

Group 5: alkoxylamino, alkylamino, or arylamino of from 1 to 24 carbon atoms; and

Group 6: fluorine, keto, chlorine, bromine or cyano. Of these substituents, those of groups 1, 2, and 6 are preferred. Most preferred are where R₉ and R₁₀ are alkyl, phenyl or connected to make a spirofluorene derivative. Representative examples of this class of materials are Host-11 and Host-17 as well as spirofluorenes such as Host-20 and those described in US2006183042.

The following table lists some representative structures of suitable hosts to be used in combination with a particular fluorescent blue-emitting emitter so long as the combination meets the energy relationships of this invention. It should be noted that these same materials can also be used as hosts or co-hosts in combination with a phosphorescent emitter so long as the combination meets the energy relationships of this invention.

Energy Levels of Hosts for Fluorescent Layers

| | HOMO | LUMO | Triplet | |
|---|---|---|---|---|
| Identifier | Energy | Energy | Energy | Structure |
| Host-1 | −5.54 | −2.41 | 2.25 | 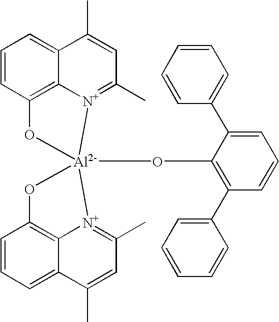 |
| Host-2 | −5.58 | −2.50 | 2.21 | 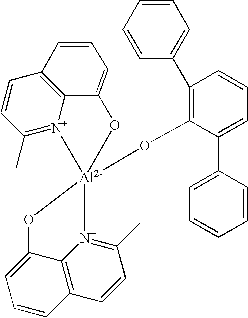 |
| Host-3(BPHFL) | −5.74 | −2.57 | 2.29 | 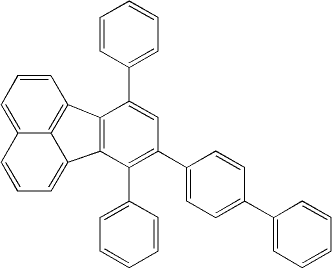 |
| Host-4(Balq) | −5.50 | −2.53 | 2.25 | 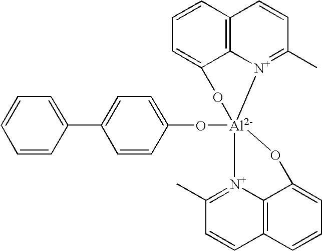 |
| Host-5(TBADN) | −5.44 | −2.40 | 1.86 | 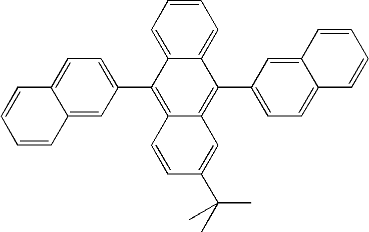 |

### Spacer Layer 110

As described above, the presence of a spacer layer located between the layer containing the fluorescent emitter and the layer containing the phosphorescent layer is crucial for the efficient utilization of both singlet and triplet excitons. The material used in the spacer layer should be selected on the basis of its triplet energy relative to the triplet energies of the host of the fluorescent layer. In particular, triplet energy of the fluorescent host should be not more than 0.2 eV less than the triplet energy of both the spacer layer material. It is also desirable that the triplet energy of the spacer material is not more than 0.2 eV below that of the phosphorescent host material or more desirably, equal to or greater than the phosphorescent host material. More suitably, the triplet energy of the fluorescent host should be equal or greater to the triplet energy of the spacer material.

Ideally, the spacer layer does not contain any emitters or emissive materials and the spacer layer will be some other suitably selected material meeting the criteria for the triplet energy in relation to the fluorescent host material. The spacer layer may contain one or more materials. It is most desirable for the spacer material to be the same as the host for either the fluorescent or phosphorescent or even both. The spacer layer should be thin in thickness, ideally ranging from 1 nm to 10 nm, although thicker layers may be required in some applications.

Preferred classes of materials for the spacer layers are the same classes that are preferred for hosts in the light-emitting layers. Particularly useful classes include the metal-chelated oxinoid host compounds of formula (MCOH-b) and organic gallium complexes of formula (GH).

### Phosphorescent Light Emitting Layers 111

The light-emitting phosphorescent guest material(s) or emitter is typically present in an amount of from 1 to 20 by weight % of the light-emitting layer, and conveniently from 2 to 8% by weight of the light-emitting layer. In some embodiments, the phosphorescent complex guest material(s) may be attached to one or more host materials. The host materials may further be polymers. For convenience, the phosphorescent complex guest material may be referred to herein as a phosphorescent material.

Particularly useful phosphorescent materials are described by Formula (PD) below.

| | |
|---|---|
| 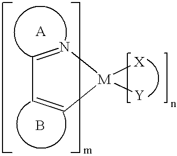 | (PD) |

wherein:
A is a substituted or unsubstituted heterocyclic ring containing at least one N atom;
B is a substituted or unsubstituted aromatic or heteroaromatic ring, or ring containing a vinyl carbon bonded to M;
X—Y is an anionic bidentate ligand;
m is an integer from 1 to 3; and
n in an integer from 0 to 2 such that m+n=3 for M═Rh or Ir; or
m is an integer from 1 to 2 and n in an integer from 0 to 1 such that m+n=2 for M═Pt or Pd.

Compounds according to Formula (PD) may be referred to as C,N-cyclometallated complexes to indicate that the central metal atom is contained in a cyclic unit formed by bonding the metal atom to carbon and nitrogen atoms of one or more ligands. Examples of heterocyclic ring A in Formula (PD) include substituted or unsubstituted pyridine, quinoline, isoquinoline, pyrimidine, indole, indazole, thiazole, and oxazole rings. Examples of ring B in Formula (PD) include substituted or unsubstituted phenyl, napthyl, thienyl, benzothienyl, furanyl rings. Ring B in Formula (PD) may also be a N-containing ring such as pyridine, with the proviso that the N-containing ring bonds to M through a C atom as shown in Formula (PD) and not the N atom.

An example of a tris-C,N-cyclometallated complex according to Formula (PD) with m=3 and n=0 is tris(2-phenyl-pyridinato-N,C^{2″}-)Iridium(III), shown below in stereodiagrams as facial (fac-) or meridional (mer-) isomers.

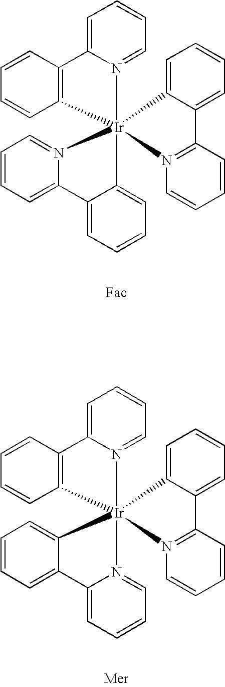

Generally, facial isomers are preferred since they are often found to have higher phosphorescent quantum yields than the meridional isomers. Additional examples of tris-C,N-cyclometallated phosphorescent materials according to Formula (PD) are tris(2-(4′-methylphenyl)pyridinato-N,C^{2′})Iridium(III), tris(3-phenylisoquinolinato-N,C^{2′})Iridium(III), tris(2-phenylquinolinato-N,C^{2′})Iridium(III), tris(1-phenylisoquinolinato-N,C^{2′})Iridium(III), tris(1-(4′-methylphenyl)isoquinolinato-N,C^{2′})Iridium(III), tris(2-(4′,6′-difluorophenyl)-pyridinato-N,C^{2′})Iridium(III), tris(2-(5′-phenyl-4′,6′-difluorophenyl)-pyridinato-N,C^{2′})Iridium(III), tris(2-(5′-phenyl-phenyl)pyridinato-N,C^{2′})Iridium(III), tris(2-(2′-benzothienyl)pyridinato-N,C^{3′})Iridium(III), tris(2-phenyl-3,3′-dimethyl)indolato-N,C^{2′})Ir(III), tris(1-phenyl-1H-indazolato-N,C^{2′})Ir(III).

Tris-C,N-cyclometallated phosphorescent materials also include compounds according to Formula (PD) wherein the monoanionic bidentate ligand X—Y is another C,N-cyclometallating ligand. Examples include bis(1-phenylisoquinolinato-N,C^{2′})(2-phenylpyridinato-N,C^{2′})Iridium(III), bis(2-phenylpyridinato-N,C^{2′})(1-phenylisoquinolinato-N,C^{2′})Iridium(III), bis(1-phenylisoquinolinato-N,C^{2′})(2-phenyl-5-methyl-pyridinato-N,C^{2′})Iridium(III), bis(1-phenylisoquinolinato-N,C^{2′})(2-phenyl-4-methyl-pyridinato-N,C^{2′})Iridium(III), and bis(1-phenylisoquinolinato-N,C^{2′})(2-phenyl-3-methyl-pyridinato-N,C^{2′})Iridium(III).

Structural formulae of some tris-C,N-cyclometallated Iridium complexes are shown below.

| | |
|---|---|
| IrPD-1 | 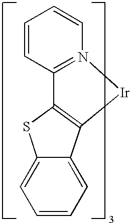 |
| IrPD-2 | 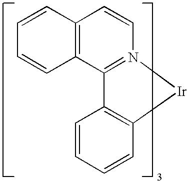 |
| IrPD-3 | 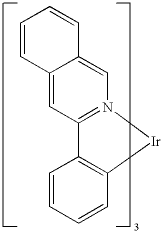 |
| IrPD-4 | 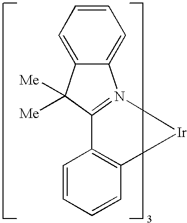 |
| IrPD-5 | 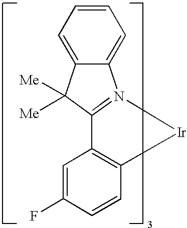 |
| IrPD-6 | 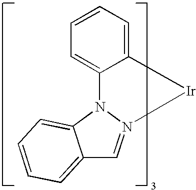 |
| IrPD-7 | 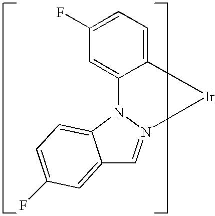 |
| IrPD-8 | 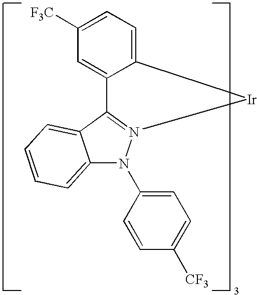 |
| IrPD-9 | 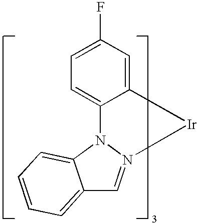 |
| IrPD-10 | 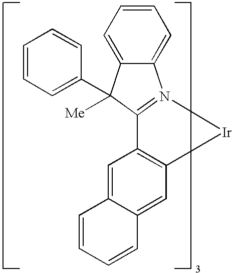 |
| IrPD-11 | 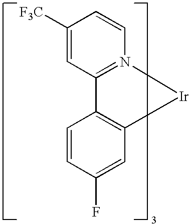 |
| IrPD-12 | 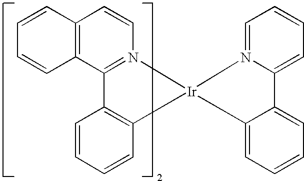 |
| IrPD-13 | 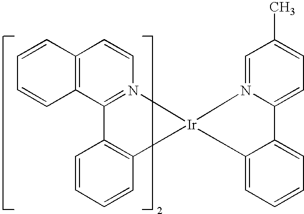 |
| IrPD-14 | 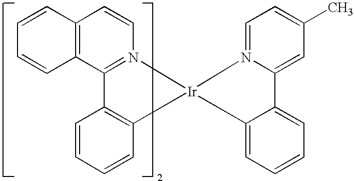 |
| IrPD-15 | 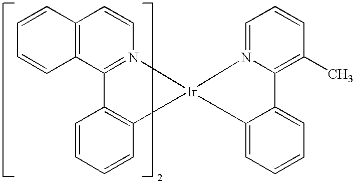 |

Suitable phosphorescent materials according to Formula (PD) may in addition to the C,N-cyclometallating ligand(s) also contain monoanionic bidentate ligand(s) X—Y that are not C,N-cyclometallating. Common examples are beta-diketonates such as acetylacetonate, and Schiff bases such as picolinate. Examples of such mixed ligand complexes according to Formula (PD) include bis(2-phenylpyridinato-N,C^{2′})Iridium(III)(acetylacetonate), bis(2-(2′-benzothienyl)pyridinato-N,C^{3′})Iridium(III)(acetylacetonate), and bis(2-(4′,6′-difluorophenyl)-pyridinato-N,C^{2′})Iridium(III)(picolinate).

Other important phosphorescent materials according to Formula (PD) include C,N-cyclometallated Pt(II) complexes such as cis-bis(2-phenylpyridinato-N,C^{2′})platinum(II), cis-bis(2-(2′-thienyl)pyridinato-N,C^{3′}) platinum(II), cis-bis(2-(2′-thienyl)quinolinato-N,C^{5′}) platinum(II), or (2-(4′,6′-difluorophenyl)pyridinato-N,C^{2′}) platinum (II) (acetylacetonate).

In addition to bidentate C,N-cyclometallating complexes represented by Formula (PD), many suitable phosphorescent emitters contain multidentate C,N-cyclometallating ligands. Phosphorescent emitters having tridentate ligands suitable for use in the present invention are disclosed in U.S. Pat. No. 6,824,895 B1 and U.S. Ser. No. 10/729,238 (pending) and references therein, incorporated in their entirety herein by reference. Phosphorescent emitters having tetradentate ligands suitable for use in the present invention are described by the following formulae:

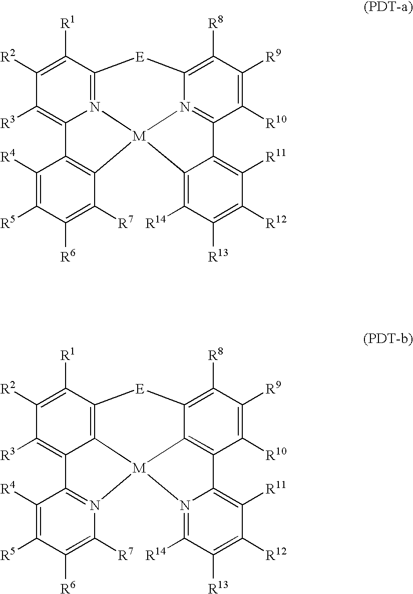

wherein:
M is Pt or Pd;
R¹-R⁷ represent hydrogen or independently selected substituents, provided that R¹ and R², R² and R³, R³ and R⁴, R⁴ and R⁵, R⁵ and R⁶, as well as R⁶ and R⁷ may join to form a ring group;
R⁸-R¹⁴ represent hydrogen or independently selected substituents, provided that R⁸ and R⁹, R⁹ and R¹⁰, R¹⁰ and R¹¹, R¹¹ and R¹², R¹² and R¹³, as well as R¹³ and R¹⁴ may join to form a ring group;
E represents a bridging group selected from the following:

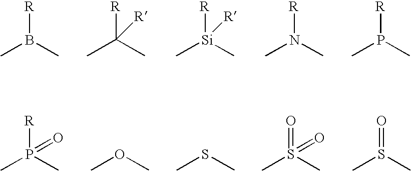

wherein R and R′ represent hydrogen or independently selected substituents; provided R and R′ may combine to form a ring group.

In one desirable embodiment, the tetradentate C,N-cyclometallated phosphorescent emitter suitable for use in the present invention is represented by the following formula:

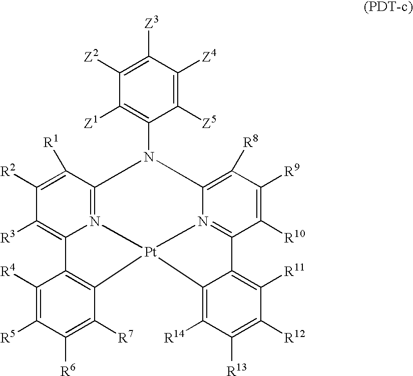

wherein,
R¹-R⁷ represent hydrogen or independently selected substituents, provided that R¹ and R², R² and R³, R³ and R⁴, R⁴ and R⁵, R⁵ and R⁶, as well as R⁶ and R⁷ may combine to form a ring group;
R⁸-R¹⁴ represent hydrogen or independently selected substituents, provided that R⁸ and R⁹, R⁹ and R¹⁰, R¹⁰ and R¹¹, R¹¹ and R¹², R¹² and R¹³, as well as R¹³ and R¹⁴ may combine to form a ring group;
Z¹-Z⁵ represent hydrogen or independently selected substituents, provided that Z¹ and Z², Z² and Z³, Z³ and Z⁴, as well as Z⁴ and Z⁵ may combine to form a ring group.

Examples of phosphorescent emitters having tetradentate C,N-cyclometallating ligands include the compounds represented below.

| | |
|---|---|
| 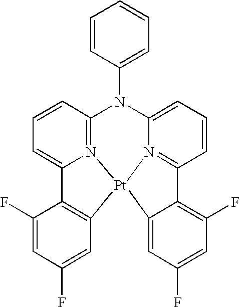 | PtPD-1 |
| 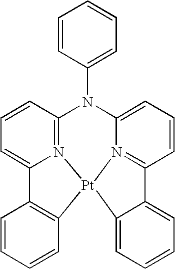 | PtPD-2 |
| 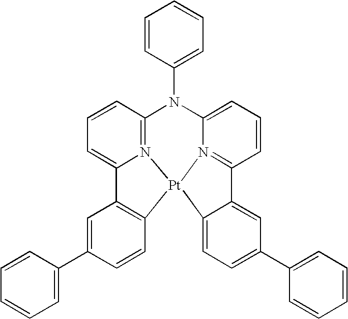 | PtPD-3 |

The emission wavelengths (color) of C,N-cyclometallated phosphorescent materials according to Formulas (PD), (PDT-a), (PDT-b) and (PDT-c) are governed principally by the lowest energy optical transition of the complex and hence by the choice of the C,N-cyclometallating ligand. For example, 2-phenyl-pyridinato-N,C^{2′} complexes are typically green emissive while 1-phenyl-isoquinolinolato-N,C^{2′} complexes are typically red emissive. In the case of complexes having more than one C,N-cyclometallating ligand, the emission will be that of the ligand having the property of longest wavelength emission. Emission wavelengths may be further shifted by the effects of substituent groups on the C,N-cyclometallating ligands. For example, substitution of electron donating groups at appropriate positions on the N-containing ring A or electron withdrawing groups on the C-containing ring B tend to blue-shift the emission relative to the unsubstituted C,N-cyclometallated ligand complex. Selecting a monodentate anionic ligand X,Y in Formula (PD) having more electron withdrawing properties also tends to blue-shift the emission of a C,N-cyclometallated ligand complex. Examples of complexes having both monoanionic bidentate ligands possessing electron-withdrawing properties and electron-withdrawing substituent groups on the C-containing ring B include bis(2-(4′,6′-difluorophenyl)-pyridinato-N,C^{2′})iridium(III)(picolinate); bis(2-[4″-trifluoromethyl-5′-phenyl-(4′,6′-difluorophenyl)-pyridinato-N,C^{2′})iridium(III)(picolinate); bis(2-(5′-phenyl-4′,6′-difluorophenyl)-pyridinato-N,C^{2′})iridium(III)(picolinate); bis(2-(5′-cyano-4′,6′-difluorophenyl)-pyridinato-N,C^{2′})iridium(III)(picolinate); bis(2-(4′,6′-difluorophenyl)-pyridinato-N,C^{2′})iridium(III)(tetrakis(1-pyrazolyl)borate); bis[2-(4′,6′-difluorophenyl)-pyridinato-N,C^{2′}]{2-[(3-trifluoromethyl)-1H-pyrazol-5-yl]pyridinato-N,N′}iridium(III);
bis[2-(4′,6′-difluorophenyl)-4-methylpyridinato-N,C^{2′}]{2-[(3-trifluoromethyl)-1H-pyrazol-5-yl]pyridinato-N,N′}iridium(III); and bis[2-(4′,6′-difluorophenyl)-4-methoxypyridinato-N,C^{2′}]{2-[(3-trifluoromethyl)-1H-pyrazol-5-yl]pyridinato-N,N′}iridium(III).

The central metal atom in phosphorescent materials according to Formula (PD) may be Rh or Ir for (m+n=3) and Pd or Pt (m+n=2). Preferred metal atoms are Ir and Pt since these tend to give higher phosphorescent quantum efficiencies according to the stronger spin-orbit coupling interactions generally obtained with elements in the third transition series.

Other phosphorescent materials that do not involve C,N-cyclometallating ligands are known. Phosphorescent complexes of Pt(II), Ir(I), and Rh(I) with maleonitriledithiolate have been reported (C. E. Johnson et al, J. Am. Chem. Soc., 105,1795-1802 (1983)). Re(I) tricarbonyl diimine complexes are also known to be highly phosphorescent (M. Wrighton and D. L. Morse, J. Am. Chem. Soc., 96,998-1003 (1974); D. J. Stufkens, Comments Inorg. Chem., 13,359-385 (1992); V. W. W. Yam, Chem. Commun., 2001, 789-796)). Os(II) complexes containing a combination of ligands including cyano ligands and bipyridyl or phenanthroline ligands have also been demonstrated in a polymer OLED (Y. Ma et al, Synthetic Metals, 94, 245-248 (1998)).

Porphyrin complexes such as 2,3,7,8,12,13,17,18-octaethyl-21H, 23H-porphine platinum(II) are also useful phosphorescent materials.

Still other examples of useful phosphorescent materials include coordination complexes of the trivalent lanthanides such as Tb³⁺ and Eu³⁺ (J. Kido et al., Chem Lett., 657 (1990); J Alloys and Compounds, 192, 30-33 (1993); Jpn J Appl Phys, 35, L394-6 (1996) and Appl. Phys. Lett., 65, 2124 (1994)).

Additional information on suitable phosphorescent materials, incorporated herein by reference, can be found in U.S. Pat. No. 6,303,238 B1, WO 00/57676, WO 00/70655, WO 01/41512 A1, US 2002/0182441 A1, US 2003/0017361 A1, US 2003/0072964 A1, U.S. Pat. No. 6,413,656 B1, U.S. Pat. No. 6,687,266 B1, US 2004/0086743 A1, US 2004/0121184 A1, US 2003/0059646 A1, US 2003/0054198 A1, EP 1 239 526 A2, EP 1 238 981 A2, EP 1 244 155 A2, US 2002/0100906 A1, US 2003/0068526 A1, US 2003/0068535 A1, JP 2003073387A, JP 2003 073388A, U.S. Pat. No. 6,677,060 B2, US 2003/0235712 A1, US 2004/0013905 A1, U.S. Pat. No. 6,733,905 B2, U.S. Pat. No. 6,780,528 B2, US 2003/0040627 A1, JP 2003059667A, JP 2003073665A, US 2002/0121638 A1, EP 1371708A1, US 2003/010877 A1, WO 03/040256 A2, US 2003/0096138 A1, US 2003/0173896 A1, U.S. Pat. No. 6,670645 B2, US 2004/0068132 A1, WO 2004/015025 A1, US 2004/0072018 A1, US 2002/0134984 A1, WO 03/079737 A2, WO 2004/020448 A1, WO 03/091355 A2, U.S. Ser. No. 10/729,402, U.S. Ser. No. 10/729,712, U.S. Ser. No. 10/729,738, U.S. Ser. No. 10/729,238, U.S. Pat. No. 6,824,895 B1, U.S. Ser. No. 10/729,207 (now allowed), and U.S. Ser. No. 10/729,263 (now allowed).

Energies (in eV) for suitable phosphorescent materials are shown in the table below:

Phosphorescent Emitters

| | HOMO | LUMO | Triplet | |
|---|---|---|---|---|
| Identifier | Energy | Energy | Energy | Structure |
| Ir(piq)₃ | −5.24 | −2.63 | 2.12 | 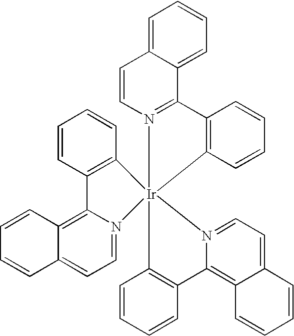 |
| Ir(ppy)₃ | −5.27 | −2.10 | 2.54 | 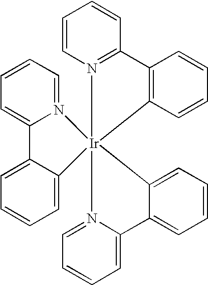 |
| OEPPT | −5.40 | −2.67 | 2.13 | 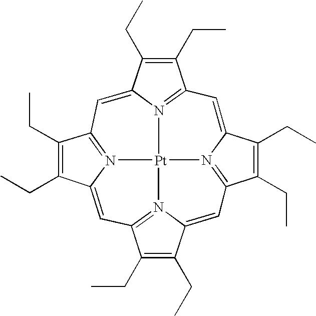 |
| IrBPT | −5.23 | −2.38 | 2.19 | 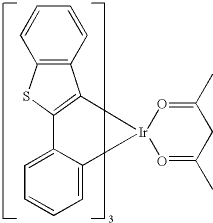 |
| IR(ppy)₂C | −5.45 | −2.33 | 2.36 | 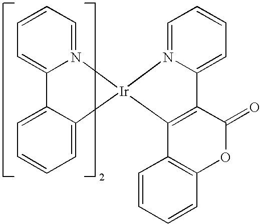 |

Types of suitable triplet host materials may further be categorized according to their charge transport properties. Types thus include hosts that are predominantly electron transporting and those that are predominantly hole transporting. It should be noted that some host materials which may be categorized as transporting dominantly one type of charge carrier, may transport both types of charge carriers in certain device structures, as reported for CBP by C. Adachi, R. Kwong, and S. R. Forrest, Organic Electronics, 2, 37-43 (2001). Another type of host are those having wide energy gaps between the HOMO and LUMO such that they do not readily transport charges of either type and instead rely on charge injection directly into the phosphorescent emitter molecules. Finally, host materials may comprise a mixture of two or more host materials. However, a mixture comprising at least one each of an electron transporting and a hole transporting co-host is not particularly useful in the present invention because it allows charge recombination to occur in different regions of the device although it may be possible to avoid this problem by varying concentrations of co-host(s) to confine or restrict the recombination zone to a certain region of the LEL.

A desirable electron transporting host or co-host may be any suitable electron transporting compound, such as benzazole, phenanthroline, 1,3,4-oxadiazole, triazole, triazine, organic gallium complex or triarylborane, as long as it has a triplet energy that is higher than that of the phosphorescent emitter to be employed.

A preferred class of benzazoles is described by Jianmin Shi et al. in U.S. Pat. No. 5,645,948 and U.S. Pat. No. 5,766,779. Such compounds are represented by structural formula (BAH):

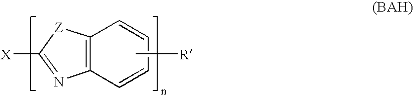

In formula (BAH), n is selected from 2 to 8;

Z is independently O, NR or S;

R and R′ are individually hydrogen; alkyl of from 1 to 24 carbon atoms, for example, propyl, t-butyl, heptyl, and the like; aryl or hetero-atom substituted aryl of from 5 to 20 carbon atoms, for example, phenyl and naphthyl, furyl, thienyl, pyridyl, quinolinyl and other heterocyclic systems; or halo such as chloro, fluoro; or atoms necessary to complete a fused aromatic ring; and

X is a linkage unit consisting of carbon, alkyl, aryl, substituted alkyl, or substituted aryl, which conjugately or unconjugately connects the multiple benzazoles together.

An example of a useful benzazole is 2,2′,2″-(1,3,5-phenylene)tris[1-phenyl-1H-benzimidazole] (TPBI) represented as shown below:

| | |
|---|---|
| TPBI(Host-9) | 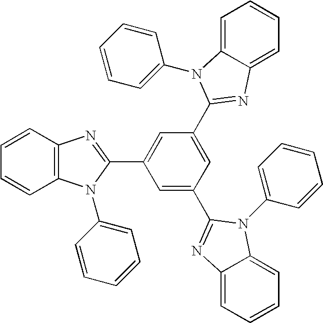 |

Another class of the electron transporting materials suitable for use as a host or co-host includes various substituted phenanthrolines as represented by formula (PH):

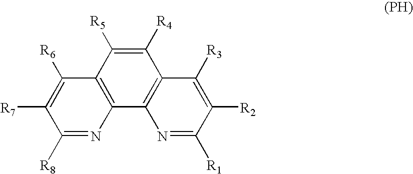

In formula (PH), R₁-R₈ are independently hydrogen, alkyl group, aryl or substituted aryl group, and at least one of R₁-R₈ is aryl group or substituted aryl group.

Examples of particularly suitable materials of this class are 2,9-dimethyl-4,7-diphenyl-1,10-phenanthroline (BCP) and 4,7-diphenyl-1,10-phenanthroline (Bphen).

| | |
|---|---|
| BCP | 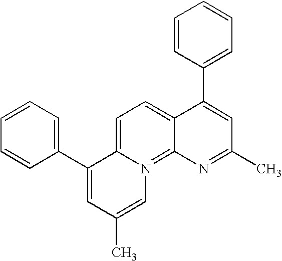 |
| Bphen(Host-12) | 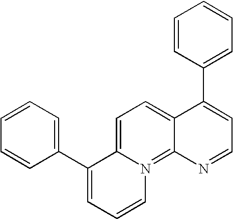 |

The triarylboranes that function as the electron transporting host or co-host in the present invention may be selected from compounds having the chemical formula (TBH):

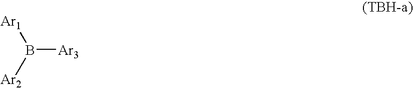

wherein

Ar₁ to Ar₃ are independently an aromatic hydrocarbocyclic group or an aromatic heterocyclic group which may have a substituent. It is preferable that compounds having the above structure are selected from formula (TBH-b):

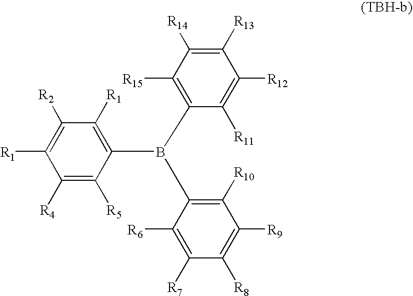

wherein R₁-R₁₅ are independently hydrogen, fluoro, cyano, trifluoromethyl, sulfonyl, alkyl, aryl or substituted aryl group.

Specific representative embodiments of the triarylboranes include:

| | |
|---|---|
| TBH-1 | 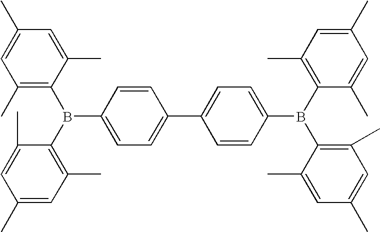 |
| TBH-2 | 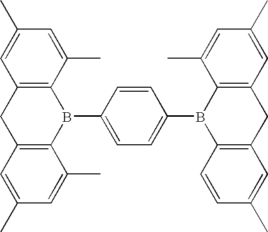 |
| TBH-3 | 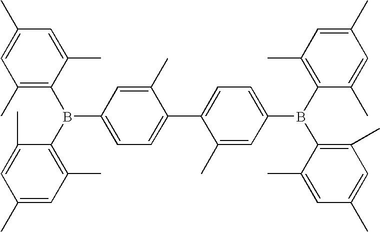 |

The electron transporting host or co-host in the present invention may be selected from substituted 1,3,4-oxadiazoles. Illustrative of the useful substituted oxadiazoles are the following:

| | |
|---|---|
| ODH-1 | 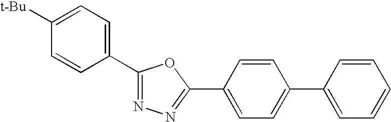 |
| ODH-2 | 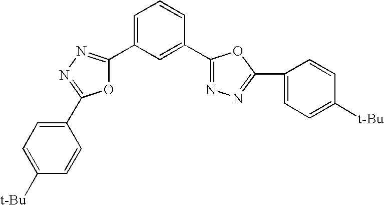 |

The electron transporting host or co-host in the present invention also may be selected from substituted 1,2,4-triazoles. An example of a useful triazole is 3-phenyl-4-(1-naphtyl)-5-phenyl-1,2,4-triazole:

| | |
|---|---|
| PNPT-1 | 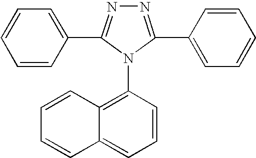 |

The electron transporting host or co-host in the present invention also may be selected from substituted 1,3,5-triazines. Examples of suitable materials are:
2,4,6-tris(diphenylamino)-1,3,5-triazine;
2,4,6-tricarbazolo-1,3,5-triazine;
2,4,6-tris(N-phenyl-2-naphthylamino)-1,3,5-triazine;
2,4,6-tris(N-phenyl-1-naphthylamino)-1,3,5-triazine;
4,4′,6,6′-tetraphenyl-2,2′-bi-1,3,5-triazine;
2,4,6-tris([1,1′:3′,1″-terphenyl]-5′-yl)-1,3,5-triazine.

Another class of desirable electron transporting host are organic gallium complexes such as those described in US20070003786A1. These are gallium complexes of “n” bidentate ligands having Formula (GH):

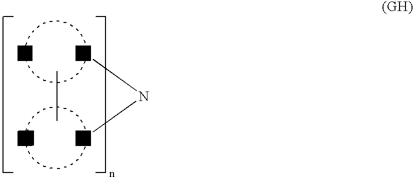

wherein:

M represents Gallium;

n is 3; and

each Z^{a} and each Z^{b} is independently selected and each represents the atoms necessary to complete an unsaturated ring;

Z^{a} and Z^{b} are directly bonded to one another provided Z^{a} and Z^{b} may be further linked together to form a fused ring system.

Preferred compounds according to GH are where Z^{a} represents one heterocyclic ring and Z^{b} represents a different heterocyclic ring. Preferred heterocyclic rings are pyridine, imidazole, benzimidazole, quinoline, triazole, and tetrazole. A specific example of a compound according to Formula (GH-1) is Host-13.

A desirable hole transporting host or co-host may be any suitable hole transporting compound, such as a triarylamine or a carbazole, as long it has a triplet energy higher than that of the phosphorescent emitter to be employed.

A suitable class of hole transporting compounds for use as a host or co-host for the phosphorescent emitter of the present invention are aromatic tertiary amines, by which it is understood to be compounds containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen containing group are disclosed by Brantley et al. in U.S. Pat. No. 3,567,450 and U.S. Pat. No. 3,658,520.

A more preferred class of aromatic tertiary amines are those which include at least two aromatic tertiary amine moieties as described in U.S. Pat. No. 4,720,432 and U.S. Pat. No. 5,061,569. Such compounds include those represented by structural formula (ATA-a):

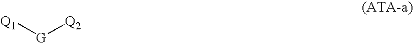

wherein Q₁ and Q₂ are independently selected aromatic tertiary amine moieties, and G is a linking group such as an arylene, cycloalkylene, or alkylene group of a carbon to carbon bond. In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural formula (ATA-a) and containing two triarylamine moieties is represented by structural formula (ATA-b):

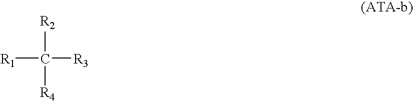

wherein

R₁ and R₂ each independently represents a hydrogen atom, an aryl group, or an alkyl group; or R₁ and R₂ together represent the atoms completing a cycloalkyl group; and

R₃ and R₄ each independently represents an aryl group, which is in turn substituted with a diaryl substituted amino group, as indicated by structural formula (ATA-c):

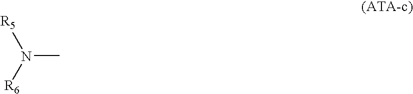

wherein R₅ and R₆ are independently selected aryl groups. In one embodiment, at least one of R₅ or R₆ contains a polycyclic fused ring structure, e.g., a naphthalene.

Another class of aromatic tertiary amines is the tetraaryldiamines. Desirable tetraaryldiamines include two diarylamino groups, such as indicated by formula (ATA-c), linked through an arylene group. Useful tetraaryldiamines include those represented by formula (TADA):

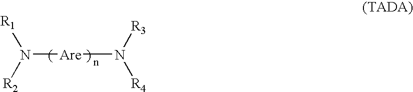

wherein each Are is an independently selected arylene group, such as a phenylene or anthracene moiety,

n is selected from 1 to 4, and

R₁-R₄ are independently selected aryl groups.

In a typical embodiment, at least one of R₁-R₄ is a polycyclic fused ring structure, e.g., a naphthalene.

The various alkyl, alkylene, aryl, and arylene moieties of the foregoing structural formulas (ATA-a to -c), and (TADA) can each in turn be substituted. Typical substituents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms, such as cyclopentyl, cyclohexyl, and cycloheptyl ring structures. The aryl and arylene moieties are usually phenyl and phenylene moieties.

Representative examples of the useful compounds include the following:
4,4′-Bis[N-(1-naphthyl)-N-phenylamino]biphenyl (NPB; Host-7);
4,4′-Bis[N-(1-naphthyl)-N-(2-naphthyl)amino]biphenyl (TNB);
4,4′-Bis[N-(3-methylphenyl)-N-phenylamino]biphenyl (TPD);
4,4′-Bis-diphenylamino-terphenyl;
2,6,2′,6′-tetramethyl-N,N,N′,N′-tetraphenyl-benzidine.

In one suitable embodiment the hole transporting host or co-host comprises a material of formula (ATA-d):

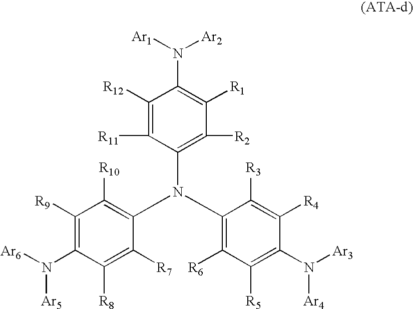

In formula (ATA-d), Ar₁-Ar₆ independently represent aromatic groups, for example, phenyl groups or tolyl groups;

R₁-R₁₂ independently represent hydrogen or independently selected substituent, for example an alkyl group containing from 1 to 4 carbon atoms, an aryl group, a substituted aryl group.

Examples of the suitable materials include, but are not limited to:
4,4′,4″-tris[(3-methylphenyl)phenylamino]triphenylamine (MTDATA);
4,4′,4″-tris(N,N-diphenyl-amino)triphenylamine (TDATA);
N,N-bis[2,5-dimethyl-4-[(3-methylphenyl)phenylamino]phenyl]-2,5-dimethyl-N′-(3-methylphenyl)-N′-phenyl-1,4-benzenediamine.

In one desirable embodiment the hole transporting host or co-host comprises a material of formula (ATA-e):

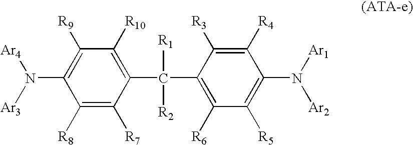

In formula (ATA-e), R₁ and R₂ represent substituents, provided that R₁ and R₂ can join to form a ring. For example, R₁ and R₂ can be methyl groups or join to form a cyclohexyl ring;

Ar₁-Ar₄ represent independently selected aromatic groups, for example phenyl groups or tolyl groups;

R₃-R₁₀ independently represent hydrogen, alkyl, substituted alkyl, aryl, substituted aryl group.

Examples of suitable materials include, but are not limited to:
1,1-Bis(4-(N,N-di-p-tolylamino)phenyl)cyclohexane (TAPC);
1,1-Bis(4-(N,N-di-p-tolylamino)phenyl)cyclopentane;
4,4′-(9H-fluoren-9-ylidene)bis[N,N-bis(4-methylphenyl)-benzenamine;
1,1-Bis(4-(N,N-di-p-tolylamino)phenyl)-4-phenylcyclohexane;
1,1-Bis(4-(N,N-di-p-tolylamino)phenyl)-4-methylcyclohexane;
1,1-Bis(4-(N,N-di-p-tolylamino)phenyl)-3-phenylpropane;
Bis[4-(N,N-diethylamino)-2-methylphenyl](4-methylpenyl)methane;
Bis[4-(N,N-diethylamino)-2-methylphenyl](4-methylphenyl)ethane;
4-(4-Diethylaminophenyl)triphenylmethane;
4,4′-Bis(4-diethylaminophenyl)diphenylmethane.

A useful class of triarylamines suitable for use as the hole transporting host or co-host includes carbazole derivatives such as those represented by formula (CAH-a):

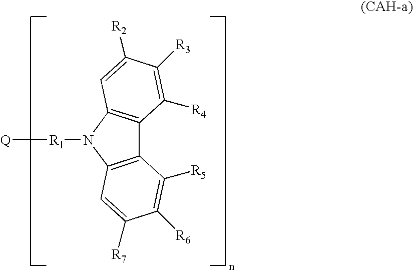

In formula (CAH), Q independently represents nitrogen, carbon, an aryl group, or substituted aryl group, preferably a phenyl group;

R₁ is preferably an aryl or substituted aryl group, and more preferably a phenyl group, substituted phenyl, biphenyl, substituted biphenyl group;

R₂ through R₇ are independently hydrogen, alkyl, phenyl or substituted phenyl group, aryl amine, carbazole, or substituted carbazole; and n is selected from 1 to 4.

Another useful class of carbazoles satisfying structural formula (CAH-a) is represented by formula (CAH-b):

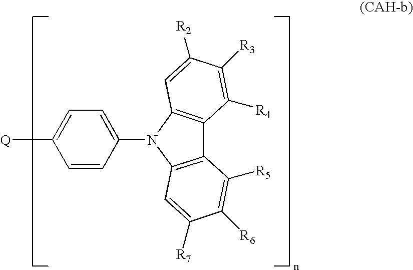

wherein n is an integer from 1 to 4;

Q is nitrogen, carbon, an aryl, or substituted aryl;

R₂ through R₇ are independently hydrogen, an alkyl group, phenyl or substituted phenyl, an aryl amine, a carbazole and substituted carbazole.

Illustrative of useful substituted carbazoles are the following:
4-(9H-carbazol-9-yl)-N,N-bis[4-(9H-carbazol-9-yl)phenyl]-benzenamine (TCTA);
4-(3-phenyl-9H-carbazol-9-yl)-N,N-bis[4(3-phenyl-9H-carbazol-9-yl)phenyl]-benzenamine;
9,9′-[5′-[4-(9H-carbazol-9-yl)phenyl][1,1′:3′,1″-terphenyl]-4,4″-diyl]bis-9H-carbazole.

In one suitable embodiment the hole transporting host or co-host comprises a material of formula (CAH-c):

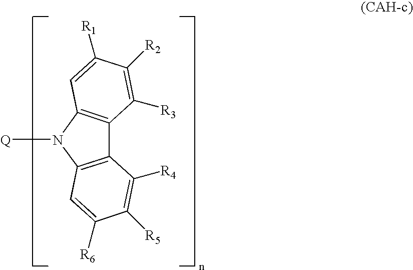

In formula (CAH-c), n is selected from 1 to 4;

Q independently represents phenyl group, substituted phenyl group, biphenyl, substituted biphenyl group, aryl, or substituted aryl group;

R₁ through R₆ are independently hydrogen, alkyl, phenyl or substituted phenyl, aryl amine, carbazole, or substituted carbazole.

Examples of suitable materials are the following:
9,9′-(2,2′-dimethyl[1,1′-biphenyl]-4,4′-diyl)bis-9H-carbazole (CDBP);
9,9′-[1,1′-biphenyl]-4,4′-diyl)bis-9H-carbazole (CBP; Host-8);
9,9′-(1,3-phenylene)bis-9H-carbazole (MCP; Host-10);
9,9′-(1,4-phenylene)bis-9H-carbazole;
9,9′,9″-(1,3,5-benzenetriyl)tris-9H-carbazole;
9,9′-(1,4-phenylene)bis[N,N,N′,N′-tetraphenyl-9H-carbazole-3,6-diamine;
9-[4-(9H-carbazol-9-yl)phenyl]-N,N-diphenyl-9H-carbazol-3-amine;
9,9′-(1,4-phenylene)bis[N,N-diphenyl-9H-carbazol-3-amine;
9-[4-(9H-carbazol-9-yl)phenyl]-N,N,N′,N′-tetraphenyl-9H-carbazole-3,6-diamine.

Recently, it was disclosed that some carbazole derivatives may be useful as electron-transporting host materials (WO2006/115700a2).

Thompson et al. disclosed in US 2004/0209115A1 and US 2004/0209116A1 a group of wide energy gap hosts having triplet energies suitable for blue phosphorescent OLEDs. Such compounds include those represented by structural formula (WEGH):

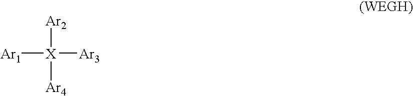

wherein:

A is Si or Pb; Ar1, Ar2, Ar3 and Ar4 are each an aromatic group independently selected from phenyl and high triplet energy heterocyclic groups such as pyridine, pyrazole, thiophene, etc. The approach taken here to maximize the HOMO-LUMO gaps in these materials is to electronically isolate each aromatic unit, avoiding any conjugating substituents.

Illustrative examples of this type of hosts include:

| | |
|---|---|
| 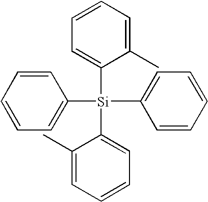 | WEGH-1 |
| 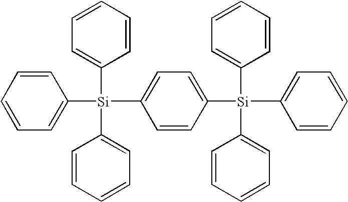 | WEGH-2 |
| 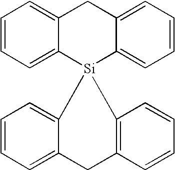 | WEGH-3 |

These “wide energy gap” materials shown above have very deep HOMOs and high LUMOs. Thus, the HOMO and LUMO of the emissive emitter are within the HOMO and LUMO for the host. In this case, the emitter acts as the primary charge carrier for both electrons and holes, as well as the site for the trapping of excitons. The “wide energy gap” host material functions as a non-charge carrying material in the system. Such a combination may lead to high operation voltage of the device, as the concentration of the charge-carrying emitter is typically below 10% in the emissive layer.

Increasing the charge carrying abilities of the “wide energy gap” host materials can be realized by incorporating substituents with electron-withdrawing or electron-donating properties. Electron transporting “wide energy gap” hosts having electron-withdrawing groups are disclosed in Thompson et al. cited above. Specific examples are shown below:

| | |
|---|---|
| 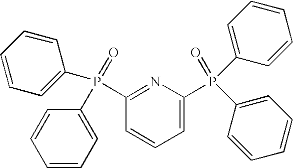 | WEGH-4 |
| 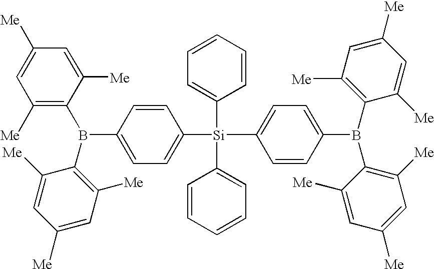 | WEGH-5 |
| 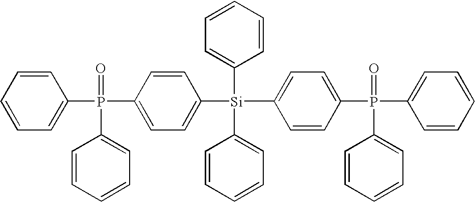 | WEGH-6 |

Another suitable class of compounds for use as a host or co-host for the phosphorescent emitter of the present invention are benzoperylene derivatives as described in U.S. Pat. No. 7,175,922, US Apps 20050106415 and 2004076853 and JP2002359081. These materials are according to formula (BP):

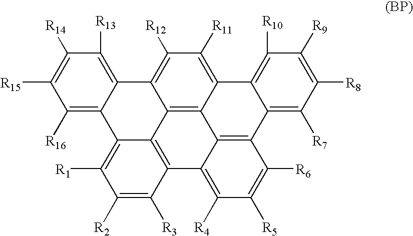

where R₁-R₁₆ each independently represents hydrogen, halo, alkyl (straight, branched or cyclic). aryl (unsubstituted or substituted), aryloxy, alkyloxy or amino groups with the proviso that neighboring groups may form additional annulated rings. A specific example of this class is host-17.

The host may comprise at least one electron-transporting co-host and at least one hole-transporting co-host although this arrangement is often not suitable for the purposes of this invention. The optimum concentration of the hole transporting co-host(s) in the present invention may be determined by experimentation and may be within the range 10 to 60 weight % of the total of the hole- and electron transporting co-host materials in the light emitting layer, and is often found to be in the range 15 to 30 wt. %. The optimum concentration of the electron transporting co-host in the present invention may be determined by experimentation and may be within the range from 40 to 90 weight %, and is often found to be in the range from 70 to 85 weight %. It is further noted that electron-transporting molecules and hole-transporting molecules may be covalently joined together to from a single host molecule having both electron-transporting and hole-transporting properties.

The following table lists some representative structures of suitable hosts to be used in combination with a particular phosphorescent emitter so long as the combination meets the energy relationships of this invention. It should be noted that these same materials can also be used as hosts or co-hosts in combination with a fluorescent emitter so long as the combination meets the energy relationships of this invention.

Hosts for Phosphorescent Emitters

| | HOMO | LUMO | Triplet | |
|---|---|---|---|---|
| Identifier | Energy | Energy | Energy | Structure |
| Host-6(TCTA) | −5.43 | −1.88 | 2.85 | 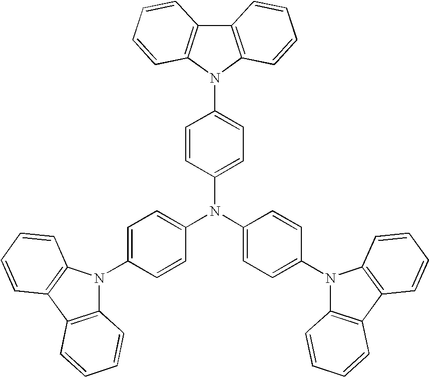 |
| Host-7(NPB) | −5.19 | −2.06 | 2.50 | 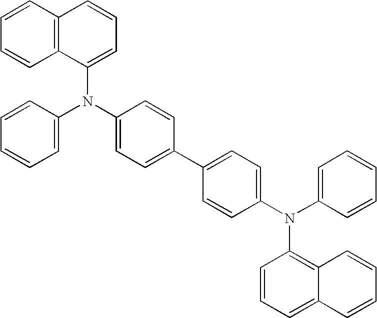 |
| Host-8(CBP) | −5.58 | −2.13 | 2.67 | 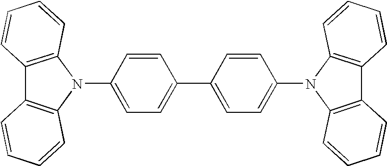 |
| Host-9(TPBI) | −5.79 | −2.09 | 2.69 | 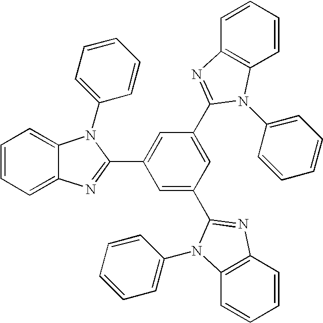 |
| Host-10(MCP) | −5.68 | −1.75 | 3.15 | 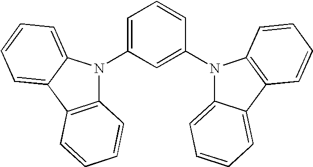 |
| Host-11 | −5.88 | −2.54 | 2.95 | 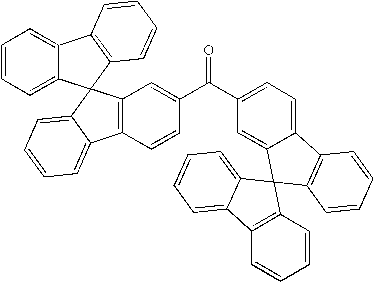 |
| Host-12(BPhen) | −6.03 | −2.29 | 2.64 | 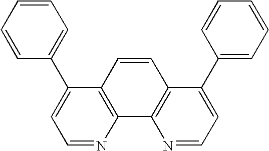 |
| Host-13 | −5.63 | −2.42 | 2.57 | 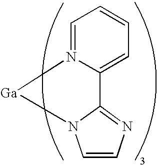 |
| Host-14 | −5.69 | −2.69 | 2.43 | 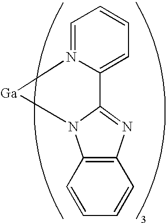 |
| Host-15 | −5.15 | −1.30 | 2.95 | 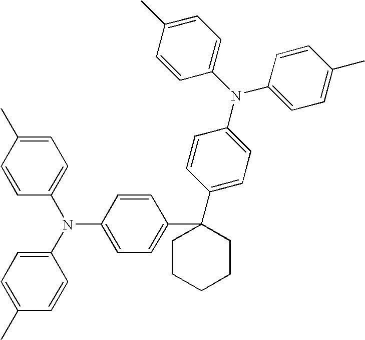 |
| Host-16(mtdata) | −4.93 | −1.51 | 2.65 | 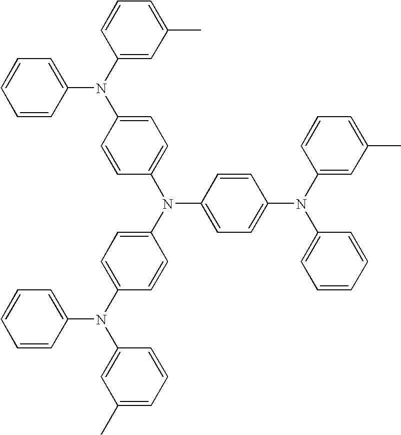 |
| Host-17 | −5.63 | −2.39 | 2.47 | 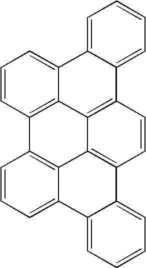 |
| Host-18(ALQ) | −5.36 | −2.51 | 2.11 | 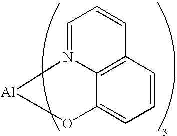 |
| Host-19(rubrene) | −5.17 | −2.85 | 1.24 | 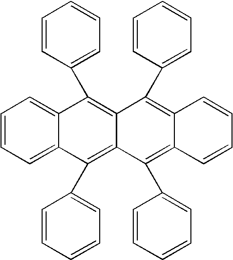 |
| Host-20 | −5.55 | −2.26 | 2.47 | 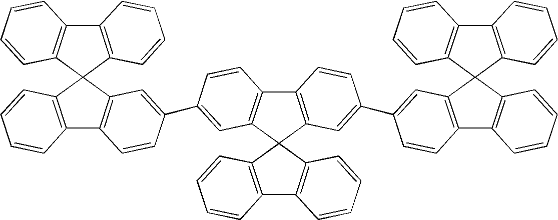 |
| Host-21(ADN) | −5.49 | −2.45 | 1.84 | 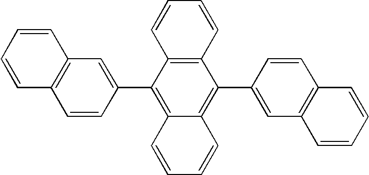 |
| Host-21(BCP) | −5.91 | −2.16 | 2.61 | 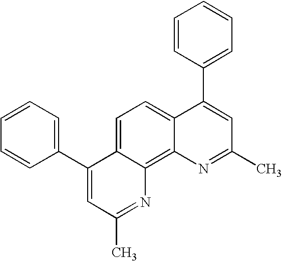 |
| Host-22 | −5.58 | −2.30 | 2.76 | 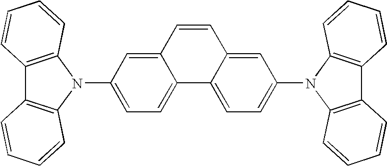 |

### General Device Architecture

The present invention can be employed in many OLED device configurations using small molecule materials, oligomeric materials, polymeric materials, or combinations thereof. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

There are numerous configurations of the organic layers wherein the present invention can be successfully practiced. The essential requirements of an OLED are an anode, a cathode, and an organic light emitting layer located between the anode and cathode. Additional layers may be employed as more fully described hereafter.

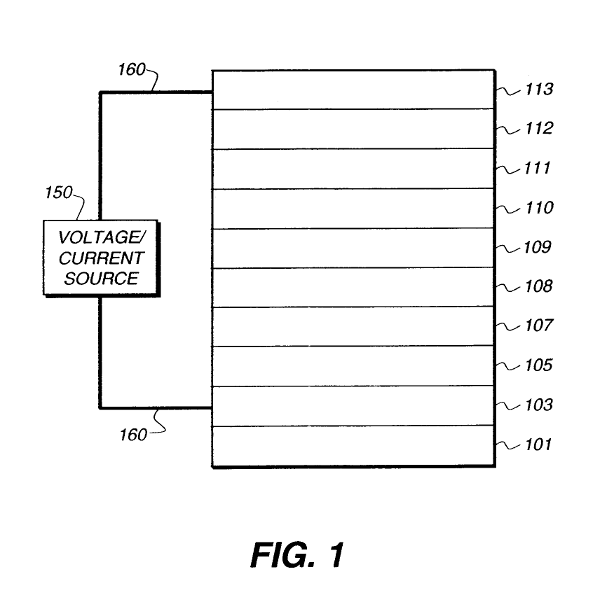

A schematic of a typical structure according to the present invention and especially useful for a small molecule device is shown in FIG. 1. OLED 100 in FIG. 1 includes anode 103, HTL 107, an exciton blocking layer 108, a fluorescent LEL 109, a spacer layer 110, a phosphorescent LEL 111, ETL 112 and cathode 113. OLED 100 can be operated by applying an electric potential produced by a voltage/current source 150 between the pair of the electrodes, anode 103 and cathode 113.

These layers are described in detail below. Note that the substrate 101 may alternatively be located adjacent to the cathode 113, or the substrate 101 may actually constitute the anode 103 or cathode 113. The organic layers between the anode 103 and cathode 113 are conveniently referred to as the organic EL element. Also, the total combined thickness of the organic layers is desirably less than 500 nm.

The anode 103 and cathode 113 of the OLED are connected to a voltage/current source 150 through electrical conductors 160. The OLED is operated by applying a potential between the anode 103 and cathode 113 such that the anode 103 is at a more positive potential than the cathode 113. Holes are injected into the organic EL element from the anode 103 and electrons are injected into the organic EL element at the cathode 113. Enhanced device stability can sometimes be achieved when the OLED is operated in an AC mode where, for some time period in the AC cycle, the potential bias is reversed and no current flows. An example of an AC driven OLED is described in U.S. Pat. No. 5,552,678.

### Substrate 101

The OLED device of this invention is typically provided over a supporting substrate 101 where either the cathode 113 or anode 103 can be in contact with the substrate. The electrode in contact with the substrate 101 is conveniently referred to as the bottom electrode. Conventionally, the bottom electrode is the anode 103, but this invention is not limited to that configuration. The substrate 101 can either be light transmissive or opaque, depending on the intended direction of light emission. The light transmissive property is desirable for viewing the EL emission through the substrate 101. Transparent glass or plastic is commonly employed in such cases. The substrate 101 can be a complex structure comprising multiple layers of materials. This is typically the case for active matrix substrates wherein TFTs are provided below the OLED layers. It is still necessary that the substrate 101, at least in the emissive pixelated areas, be comprised of largely transparent materials such as glass or polymers. For applications where the EL emission is viewed through the top electrode, the transmissive characteristic of the bottom support is immaterial, and therefore the substrate can be light transmissive, light absorbing or light reflective. Substrates for use in this case include, but are not limited to, glass, plastic, semiconductor materials such as silicon, ceramics, and circuit board materials. Again, the substrate 101 can be a complex structure comprising multiple layers of materials such as found in active matrix TFT designs. It is necessary to provide in these device configurations a light-transparent top electrode.

### Anode 103

When the desired electroluminescent light emission (EL) is viewed through the anode, the anode 103 should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode 103. For applications where EL emission is viewed only through the cathode 113, the transmissive characteristics of the anode 103 are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize short circuits or enhance reflectivity.

### Cathode 113

When light emission is viewed solely through the anode 103, the cathode 113 used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One useful cathode material is comprised of a Mg:Ag alloy wherein the percentage of silver is in the range of 1 to 20%, as described in U.S. Pat. No. 4,885,221. Another suitable class of cathode materials includes bilayers comprising the cathode and a thin electron injecting layer (EIL) in contact with an organic layer (e.g., an electron transporting layer (ETL)), the cathode being capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. An ETL material doped with an alkali metal, for example, Li-doped Alq, is another example of a useful EIL. Other useful cathode material sets include, but are not limited to, those disclosed in U.S. Pat. Nos. 5,059,861, 5,059,862, and 6,140,763.

When light emission is viewed through the cathode, the cathode 113 must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,3936. Cathode materials are typically deposited by any suitable method such as evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

### Hole Injecting Layer (HIL) 105

A hole injecting layer 105 may optionally be provided between anode 103 and hole transporting layer 107. The hole injecting layer can serve to improve the film formation property of subsequent organic layers and to facilitate injection of holes into the hole transporting layer 107. Suitable materials for use in the hole injecting layer include, but are not limited to, porphyrinic compounds as described in U.S. Pat. No. 4,720,432, plasma-deposited fluorocarbon polymers as described in U.S. Pat. No. 6,208,075, and some aromatic amines, for example, MTDATA (4,4′,4″-tris[(3-methylphenyl)phenylamino]triphenylamine). Alternative hole injecting materials reportedly useful in organic EL devices are described in EP 0 891 121 A1 and EP 1 029 909 A1. A hole injection layer is conveniently used in the present invention, and is desirably a plasma-deposited fluorocarbon polymer.

The thickness of a hole injection layer containing a plasma-deposited fluorocarbon polymer can be in the range of 0.2 nm to 15 nm and suitably in the range of 0.3 to 1.5 nm.

### Hole Transporting Layer (HTL) 107

In addition to the emissive layer, it is usually advantageous to have a hole transporting layer 107 deposited between the anode and the emissive layer. A hole transporting material deposited in said hole transporting layer between the anode and the light emitting layer may be the same or different from a hole transporting compound used as a co-host or in exciton blocking layer according to the invention. The hole transporting layer may optionally include a hole injection layer. The hole transporting layer may include more than one hole transporting compound, deposited as a blend or divided into separate layers.

The hole transporting layer of the organic EL device contains at least one hole transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen containing group are disclosed by Brantley et al. in U.S. Pat. No. 3,567,450 and U.S. Pat. No. 3,658,520.

A more preferred class of aromatic tertiary amines is those which include at least two aromatic tertiary amine moieties as described in U.S. Pat. No. 4,720,432 and U.S. Pat. No. 5,061,569. Such compounds include those represented by structural formula (ATA-a):

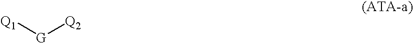

wherein

Q₁ and Q₂ are independently selected aromatic tertiary amine moieties, and G is a linking group such as an arylene, cycloalkylene, or alkylene group of a carbon to carbon bond. In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural formula (ATA-a) and containing two triarylamine moieties is represented by structural formula (ATA-b):

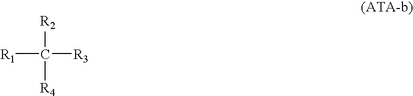

wherein

R₁ and R₂ each independently represents a hydrogen atom, an aryl group, or an alkyl group or R₁ and R₂ together represent the atoms completing a cycloalkyl group; and

R₃ and R₄ each independently represents an aryl group, which is in turn substituted with a diaryl substituted amino group, as indicated by structural formula (ATA-c):

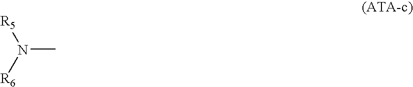

wherein

R₅ and R₆ are independently selected aryl groups. In one embodiment, at least one of R₅ or R₆ contains a polycyclic fused ring structure, e.g., a naphthalene.

Another class of aromatic tertiary amines is the tetraaryldiamines. Desirable tetraaryldiamines include two diarylamino groups, such as indicated by formula (ATA-c), linked through an arylene group. Useful tetraaryldiamines include those represented by formula (TADA):

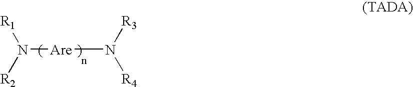

wherein

each Are is an independently selected arylene group, such as a phenylene or anthracene moiety,

n is an integer of from 1 to 4, and

R₁, R₂, R₃, and R₄ are independently selected aryl groups.

In a typical embodiment, at least one of R₁, R₂, R₃, and R₄ is a polycyclic fused ring structure, e.g., a naphthalene.

The various alkyl, alkylene, aryl, and arylene moieties of the foregoing structural formulae ATA-a to -c and TADA can each in turn be substituted. Typical substituents include alkyl groups, alkoxy groups, aryl groups, aryloxy groups, and halide such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms, such as cyclopentyl, cyclohexyl, and cycloheptyl ring structures. The aryl and arylene moieties are usually phenyl and phenylene moieties.

The hole transporting layer can be formed of a single tertiary amine compound or a mixture of such compounds. Specifically, one may employ a triarylamine, such as a triarylamine satisfying the formula (ADA-b), in combination with a tetraaryldiamine, such as indicated by formula (TADA). Illustrative of useful aromatic tertiary amines are the following:

1,1-Bis(4-di-p-tolylaminophenyl)cyclohexane (TAPC);

1,1-Bis(4-di-p-tolylaminophenyl)-4-phenylcyclohexane;

N,N,N′,N′-tetraphenyl-4,4′″-diamino-1,1′:4′,1″:4″,1′″-quaterphenyl;

Bis(4-dimethylamino-2-methylphenyl)phenylmethane;

1,4-bis[2-[4-[N,N-di(p-tolyl)amino]phenyl]vinyl]benzene (BDTAPVB);

N,N,N′,N′-Tetra-p-tolyl-4,4′-diaminobiphenyl;

N,N,N′,N′-Tetraphenyl-4,4′-diaminobiphenyl;

N,N,N′,N′-tetra-1-naphthyl-4,4′-diaminobiphenyl;

N,N,N′,N′-tetra-2-naphthyl-4,4′-diaminobiphenyl;

N-Phenylcarbazole;

4,4′-Bis[N-(1-naphthyl)-N-phenylamino]biphenyl (NPB);

4,4′-Bis[N-(3-methylphenyl)-N-phenylamino]biphenyl (TPD);

4,4′-Bis[N-(1-naphthyl)-N-(2-naphthyl)amino]biphenyl (TNB);

4,4′-Bis[N-(1-naphthyl)-N-phenylamino]p-terphenyl;

4,4′-Bis[N-(2-naphthyl)-N-phenylamino]biphenyl;

4,4′-Bis[N-(3-acenaphthenyl)-N-phenylamino]biphenyl;

1,5-Bis[N-(1-naphthyl)-N-phenylamino]naphthalene;

4,4′-Bis[N-(9-anthryl)-N-phenylamino]biphenyl;

4,4′-Bis[N-(1-anthryl)-N-phenylamino]-p-terphenyl;

4,4′-Bis[N-(2-phenanthryl)-N-phenylamino]biphenyl;

4,4′-Bis[N-(8-fluoranthenyl)-N-phenylamino]biphenyl;

4,4′-Bis[N-(2-pyrenyl)-N-phenylamino]biphenyl;

4,4′-Bis[N-(2-naphthacenyl)-N-phenylamino]biphenyl;

4,4′-Bis[N-(2-perylenyl)-N-phenylamino]biphenyl;

4,4′-Bis[N-(1-coronenyl)-N-phenylamino]biphenyl;

2,6-Bis(di-p-tolylamino)naphthalene;

2,6-Bis[di-(1-naphthyl)amino]naphthalene;

2,6-Bis[N-(1-naphthyl)-N-(2-naphthyl)amino]naphthalene;

N,N,N′,N′-Tetra(2-naphthyl)-4,4″-diamino-p-terphenyl;

4,4′-Bis {N-phenyl-N-[4-(1-naphthyl)-phenyl]amino}biphenyl;

2,6-Bis[N,N-di(2-naphthyl)amino]fluorine;

4,4′,4″-tris[(3-methylphenyl)phenylamino]triphenylamine(MTDATA);

N,N-bis[2,5-dimethyl-4-[(3-methylphenyl)phenylamino]phenyl]-2,5-dimethyl-N′-(3-methylphenyl)-N′-phenyl-1,4-benzenediamine;

4-(9H-carbazol-9-yl)-N,N-bis[4-(9H-carbazol-9-yl)phenyl]-benzenamine (TCTA);

4-(3-phenyl-9H-carbazol-9-yl)-N,N-bis[4(3-phenyl-9H-carbazol-9-yl)phenyl]-benzenamine;

9,9′-(2,2′-dimethyl[1,1′-biphenyl]-4,4′-diyl)bis-9H-carbazole (CDBP);

9,9′-[1,1′-biphenyl]-4,4′-diyl)bis-9H-carbazole (CBP);

9,9′-(1,3-phenylene)bis-9H-carbazole (mCP);

9-[4-(9H-carbazol-9-yl)phenyl]-N,N-diphenyl-9H-carbazol-3-amine;

9,9′-(1,4-phenylene)bis[N,N-diphenyl-9H-carbazol-3-amine;

9-[4-(9H-carbazol-9-yl)phenyl]-N,N,N′,N′-tetraphenyl-9H-carbazole-3,6-diamine.

Another class of useful hole transporting materials includes polycyclic aromatic compounds as described in EP 1 009 041. Tertiary aromatic amines with more than two amine groups may be used including oligomeric materials. In addition, polymeric hole transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

It is also possible for the hole transporting layer to comprise two or more sublayers of differing compositions, the composition of each sublayer being as described above.

The thickness of the hole transporting layer can be between 10 and about 500 nm and suitably between 50 and 300 nm.

### Exciton Blocking Layer (EBL) 108

As described, for example in US Apps 20060134460 and US20020008233, an exciton blocking layer 108 is useful in an OLED device employing a phosphorescent emitter. When located adjacent to a fluorescent or phosphorescent light emitting layer on the anode side, it helps to help confine triplet excitons to the light emitting layer. In order that the exciton blocking layer be capable of confining triplet excitons, the material or materials of this layer should have triplet energies that exceed that of the light emitter. Otherwise, if the triplet energy level of any material in the layer adjacent the light emitting layer is lower than that of the light emitter, often that material will quench excited states in the light emitting layer, decreasing device luminous efficiency. Preferably, the exciton blocking layer material has a triplet energy greater than that of the fluorescent host material by at least 0.15 eV. In some cases it is also desirable that the exciton blocking layer also help to confine electron-hole recombination events to the light emitting layer by blocking the escape of electrons from the light emitting layer into the exciton blocking layer.

The exciton blocking layer can be between 1 and 500 nm thick and suitably between 10 and 300 nm thick. Thicknesses in this range are relatively easy to control in manufacturing. The exciton blocking layer may include more than one compound, deposited as a blend or divided into separate layers.

In addition to having high triplet energy, the exciton blocking layer should be capable of transporting holes to a light emitting layer. Thus, materials that have good hole transporting properties also generally have good exciton blocking properties. A hole transporting material used in exciton blocking layer between the anode and the light emitting layer may be the same or different from a hole transporting compound used as a co-host in a light emitting layer.

Suitable exciton blocking materials are those according to formulas (ATA-a to -c) and (TADA) as described for use as hole transporting materials as well as compounds according to formula (ATA-d) useful for hosts or co-hosts in a phosphorescent light emitting layer. A specific example of an excellent material for this purpose is 4,4′,4″-tris(carbazolyl)-triphenylamine (TCTA).

### Light Emitting Layers (LEL)

The fluorescent 109 and phosphorescent 111 light emitting layers of the invention have been described in detail previously.

The thickness of a light emitting layer can be between 5 and about 500 nm and suitably between 10 and 200 nm.

### Hole Blocking Layer (HBL) 158

In addition to suitable hosts and transporting materials, an OLED device according to the invention may also include at least one hole blocking layer 158 placed between the electron transporting layer 112 and a light emitting layer 109 or 111 to help confine the excitons and recombination events to the light emitting layer comprising co-hosts and a phosphorescent emitter. In this case, there should be an energy barrier for hole migration from co-hosts into the hole blocking layer, while electrons should pass readily from the hole blocking layer into the light emitting layer comprising co-host materials and a phosphorescent emitter. The first requirement entails that the ionization potential of the hole blocking layer 158 be larger than that of the light emitting layer 109 or 111, desirably by 0.2 eV or more. The second requirement entails that the electron affinity of the hole blocking layer 158 not greatly exceed that of the light emitting layer 109 or 111, and desirably be either less than that of light emitting layer or not exceed that of the light emitting layer by more than about 0.2 eV.

When used with an electron transporting layer whose characteristic luminescence is green, such as an Alq-containing electron transporting layer as described below, the requirements concerning the energies of the highest occupied molecular orbital (HOMO) and lowest unoccupied molecular orbital (LUMO) of the material of the hole blocking layer frequently result in a characteristic luminescence of the hole blocking layer at shorter wavelengths than that of the electron transporting layer, such as blue, violet, or ultraviolet luminescence. Thus, it is desirable that the characteristic luminescence of the material of a hole blocking layer be blue, violet, or ultraviolet. It is further desirable that the triplet energy of the hole blocking material be greater than that of the phosphorescent material. Suitable hole blocking materials are described in WO 00/70655A2, WO 01/41512 and WO 01/93642 A1. Three examples of useful hole blocking materials are Bphen, BCP and bis(2-methyl-8-quinolinolato)(4-phenylphenolato)aluminum(III) (BAlq). The characteristic luminescence of BCP is in the ultraviolet, and that of BAlq is blue. Metal complexes other than BAlq are also known to block holes and excitons as described in US 20030068528. In addition, US 20030175553 A1 describes the use of fac-tris(1-phenylpyrazolato-N,C^{2′})iridium(III) (Irppz) for this purpose.

When a hole blocking layer is used, its thickness can be between 2 and 100 nm and suitably between 5 and 10 nm.

### Electron Transporting Layer (ETL) 112

Similarly, it is usually advantageous to have an electron transporting layer 112 deposited between the cathode and the emissive layer. The electron transporting material deposited in said electron transporting layer between the cathode and the light emitting layer may be the same or different from an electron transporting co-host material. The electron transporting layer may include more than one electron transporting compound, deposited as a blend or divided into separate layers.

Preferred thin film-forming materials for use in constructing the electron transporting layer of the organic EL devices of this invention are metal-chelated oxinoid compounds, including chelates of oxine itself (also commonly referred to as 8-quinolinol or 8-hydroxyquinoline). Such compounds help to inject and transport electrons, exhibiting high levels of performance, and are readily fabricated in the form of thin films. Exemplary of contemplated oxinoid compounds are those satisfying structural formula (MCOH-a) below:

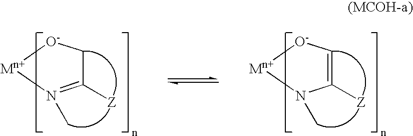

wherein

M represents a metal;

n is an integer of from 1 to 4; and

Z independently in each occurrence represents the atoms completing a nucleus having at least two fused aromatic rings.

From the foregoing it is apparent that the metal can be monovalent, divalent, trivalent, or tetravalent metal. The metal can, for example, be an alkali metal, such as lithium, sodium, or potassium; an alkaline earth metal, such as magnesium or calcium; an earth metal, such aluminum or gallium, or a transition metal such as zinc or zirconium. Generally any monovalent, divalent, trivalent, or tetravalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
MCOH-1: Aluminum trisoxine[alias, tris(8-quinolinolato)aluminum(III)];
MCOH-2: Magnesium bisoxine[alias, bis(8-quinolinolato)magnesium(II)];
MCOH-3: Bis[benzo{f}-8-quinolinolato]zinc(II);
MCOH-4: Bis(2-methyl-8-quinolinolato)aluminum(III)-μ-oxo-bis(2-methyl-8-quinolinolato)aluminum(III);
MCOH-5: Indium trisoxine[alias, tris(8-quinolinolato)indium];
MCOH-6: Aluminum tris(5-methyloxine)[alias, tris(5-methyl-8-quinolinolato)aluminum(III)];
MCOH-7: Lithium oxine[alias, (8-quinolinolato)lithium(I)];
MCOH-8: Gallium oxine[alias, tris(8-quinolinolato)gallium(III)];
MCOH-9: Zirconium oxine[alias, tetra(8-quinolinolato)zirconium(IV)].

Other electron transporting materials suitable for use in the electron transporting layer are the aluminum complexes described by formula (MCOH-b) above, which are also the compounds employed as electron transporting co-hosts in the present invention.

Other electron transporting materials suitable for use in the electron transporting layer include various butadiene derivatives as disclosed in U.S. Pat. No. 4,356,429 and various heterocyclic optical brighteners as described in U.S. Pat. No. 4,539,507.

Benzazoles satisfying structural formula (BAH) are also useful electron transporting materials:

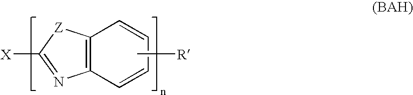

wherein

n is an integer of 3 to 8;

Z is O, NR or S; and

R and R′ are individually hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and

X is a linkage unit consisting of carbon, alkyl, aryl, substituted alkyl, or substituted aryl, which conjugately or unconjugately connects the multiple benzazoles together. An example of a useful benzazole is 2,2′,2″-(1,3,5-phenylene)tris[1-phenyl-1H-benzimidazole] (TPBI) disclosed in Shi et al. in U.S. Pat. No. 5,766,779.

Other electron transporting materials suitable for use in the electron transporting layer may be selected from triazines, triazoles, imidazoles, oxazoles, thiazoles and their derivatives, polybenzobisazoles, pyridine- and quinoline-based materials, cyano-containing polymers and perfluorinated materials.

The electron transporting layer or a portion of the electron transporting layer adjacent the cathode may further be doped with an alkali metal to reduce electron injection barriers and hence lower the drive voltage of the device. Suitable alkali metals for this purpose include lithium and cesium.

If both a hole blocking and an electron transporting layers are used in OLED device, electrons should pass readily from the electron transporting layer into the hole blocking layer. Therefore, the electron affinity of the electron transporting layer should not greatly exceed that of the hole blocking layer. Preferably, the electron affinity of the electron transporting layer should be less than that of the hole blocking layer or not exceed it by more than about 0.2 eV.

If an electron transporting layer is used, its thickness may be between 2 and 100 nm and preferably between 5 and 50 nm.

### Other Useful Organic Layers and Device Architecture

In some instances, layers 109 or 111 can optionally be collapsed with an adjacent layer into a single layer that serves the function of supporting both light emission and electron transportation. Layers 109 or 111 and 108 or 158 may also be collapsed into a single layer that functions to block holes or excitons, and supports electron transport. It also known in the art that emitting materials may be included in the hole transporting layer 107. In that case, the hole transporting material may serve as a host. Multiple materials may be added to one or more layers in order to create a white emitting OLED, for example, by combining blue- and yellow emitting materials, cyan- and red emitting materials, or red-, green-, and blue emitting materials. White emitting devices are described, for example, in EP 1 187 235, US 20020025419, EP 1 182 244, U.S. Pat. No. 5,683,823, U.S. Pat. No. 5,503,910, U.S. Pat. No. 5,405,709, and U.S. Pat. No. 5,283,182 and can be equipped with a suitable filter arrangement to produce a color emission.

This invention may be used in so-called stacked device architecture, for example, as taught in U.S. Pat. No. 5,703,436 and U.S. Pat. No. 6,337,492. Similar tandem structures are taught in U.S. Pat. No. 7,126,267 B2. The hybrid light emitting unit of the invention may be stacked with another hybrid unit of the invention or may be stacked with a light emitting unit not of the invention. For example, a highly efficient and useful stacked OLED device is prepared by using a blue fluorescent layer plus a red phosphorescent layer in a hybrid unit according to the invention stacked with a green phosphorescent unit to make a white light emitting device.

### Deposition of Organic Layers

The organic materials mentioned above are suitably deposited by any means suitable for the form of the organic materials. In the case of small molecules, they are conveniently deposited through sublimation or evaporation, but can be deposited by other means such as coating from a solvent together with an optional binder to improve film formation. If the material is a polymer, solvent deposition is usually preferred. The material to be deposited by sublimation or evaporation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. No. 5,688,551, U.S. Pat. No. 5,851,709 and U.S. Pat. No. 6,066,357) or an inkjet method (U.S. Pat. No. 6,066,357).

### Encapsulation

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOₓ, Teflon, and alternating inorganic/polymeric layers are known in the art for encapsulation. Any of these methods of sealing or encapsulation and desiccation can be used with the EL devices constructed according to the present invention.

### Optical Optimization

OLED devices of this invention can employ various well-known optical effects in order to enhance their emissive properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color-conversion filters over the display. Filters, polarizers, and anti-glare or anti-reflection coatings may be specifically provided over the EL device or as part of the EL device.

Embodiments of the invention may provide advantageous features such as higher luminous yield, low drive voltage, and higher power efficiency as well as to improve other features such as color, ease of manufacture, and operational stability. In one desirable embodiment the EL device is part of a display device. Embodiments of the invention can also provide an area lighting device. In one suitable embodiment, the EL device includes a means for emitting white light, which may include complimentary emitters, a white emitter, or a filtering means.

In accordance with this disclosure, white light is that light that is perceived by a user as having a white color, or light that has an emission spectrum sufficient to be used in combination with color filters to produce a practical full color display. For low power consumption, it is often advantageous for the chromaticity of the white light-emitting OLED to be close to CIE D65, i.e., CIE x=0.31 and CIE y=0.33. This is particularly the case for so-called RGBW displays having red, green, blue, and white pixels. Although CIEx, CIEy coordinates of about 0.31, 0.33 are ideal in some circumstances, the actual coordinates can vary significantly and still be very useful.

Unless otherwise specifically stated, use of the term “substituted” or “substituent” means any group or atom other than hydrogen. Unless otherwise provided, when a group (including a compound or complex) containing a substitutable hydrogen is referred to, it is also intended to encompass not only the unsubstituted form, but also form further substituted derivatives with any substituent group or groups as herein mentioned, so long as the substituent does not destroy properties necessary for utility. Suitably, a substituent group may be halogen or may be bonded to the remainder of the molecule by an atom of carbon, silicon, oxygen, nitrogen, phosphorous, sulfur, selenium, or boron. The substituent may be, for example, halogen, such as chloro, bromo or fluoro; nitro; hydroxyl; cyano; carboxyl; or groups which may be further substituted, such as alkyl, including straight or branched chain or cyclic alkyl, such as methyl, trifluoromethyl, ethyl, t-butyl, 3-(2,4-di-t-pentylphenoxy)propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-tolylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-tolylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-tolylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-tolylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-tolylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1(N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3 to 7 membered heterocyclic ring composed of carbon atoms and at least one hetero atom selected from the group consisting of oxygen, nitrogen, sulfur, phosphorous, or boron such as 2-furyl, 2-thienyl, 2-benzimidazolyloxy or 2-benzothiazolyl; quaternary ammonium, such as triethylammonium; quaternary phosphonium, such as triphenylphosphonium; and silyloxy, such as trimethylsilyloxy.

If desired, the substituents may themselves be further substituted one or more times with the described substituent groups. The particular substituents used may be selected by those skilled in the art to attain the desired desirable properties for a specific application and can include, for example, electron-withdrawing groups, electron-donating groups, and steric groups. When a molecule may have two or more substituents, the substituents may be joined together to form a ring such as a fused ring unless otherwise provided. Generally, the above groups and substituents thereof may include those having up to 48 carbon atoms, typically 1 to 36 carbon atoms and usually less than 24 carbon atoms, but greater numbers are possible depending on the particular substituents selected.

It is well within the skill of the art to determine whether a particular group is electron donating or electron accepting. The most common measure of electron donating and accepting properties is in terms of Hammett σ values. Hydrogen has a Hammett σ value of zero, while electron donating groups have negative Hammett σ values and electron accepting groups have positive Hammett σ values. Lange's handbook of Chemistry, 12^{th} Ed., McGraw Hill, 1979, Table 3-12, pp. 3-134 to 3-138, here incorporated by reference, lists Hammett σ values for a large number of commonly encountered groups. Hammett σ values are assigned based on phenyl ring substitution, but they provide a practical guide for qualitatively selecting electron donating and accepting groups.

Suitable electron donating groups may be selected from —R′, –OR′, and —NR′(R″) where R′ is a hydrocarbon containing up to 6 carbon atoms and R″ is hydrogen or R′. Specific examples of electron donating groups include methyl, ethyl, phenyl, methoxy, ethoxy, phenoxy, —N(CH₃)₂, —N(CH₂CH₃)₂, —NHCH₃, —N(C₆H₅)₂, —N(CH₃)(C₆H₅), and —NHC₆H₅.

Suitable electron accepting groups may be selected from the group consisting of cyano, α-haloalkyl, α-haloalkoxy, amido, sulfonyl, carbonyl, carbonyloxy and oxycarbonyl substituents containing up to 10 carbon atoms.

Specific examples include —CN, —F, —CF₃, —OCF₃, —CONHC₆H₅, —SO₂C₆H₅, —COC₆H₅, —CO₂C₆H₅, and —OCOC₆H₅.

The invention and its advantages can be better appreciated by the following examples of device structures that provide high luminous efficiency.

### EXAMPLES 1-1 TO 1-4

An EL device (Device 1-1) satisfying the requirements of the invention was constructed in the following manner:
1. A glass substrate, coated with an approximately 25 nm layer of indium-tin oxide (ITO) as the anode, was sequentially ultrasonicated in a commercial detergent, rinsed in deionized water and exposed to an oxygen plasma for about 1 minute.
2. Next, a hole transporting layer (HTL) of N,N′-di-1-naphthyl-N,N′-diphenyl-4,4′-diaminobiphenyl (Host-7 or NPB) was vacuum deposited to a thickness of 75 nm.
3. An exciton/electron blocking layer (EBL) of 4,4′,4″-tris(carbazolyl)-triphenylamine (Host-6 or TCTA) was vacuum deposited to a thickness of 10 nm.
4. A 5 nm light emitting layer (LEL1) consisting of a mixture of Host-8 as the host, and Emitter-1 as a blue fluorescent emitter present at concentration of 1 wt. % relative to the host was then vacuum deposited onto the exciton blocking layer.
5. A spacer layer of undoped Host-2 having a thickness of 5 nm was vacuum deposited over LEL1.
6. Next, a 20 nm light emitting layer (LEL2) consisting of a mixture of Host-2 as the host, and Ir(piq)₃ as a red phosphorescent emitter present at concentration of 8 wt. % was vacuum deposited onto the buffer layer.
8. An electron transporting layer (ETL) of 4,7-diphenyl-1,10-phenanthroline (Bphen) having a thickness of 20 nm was vacuum deposited over the LEL2.
9. 0.5 nm of lithium fluoride was vacuum deposited onto the EIL, followed by a 100 nm layer of aluminum, to form a bilayer cathode.

The above sequence completed the deposition of the EL device. Therefore, Device 1-1 had the following structure of layers: ITO/NPB (75 nm)/TCTA (10 nm)/Host-8+1% Emitter-1 (5 nm)/Host-2 (5 nm)/Host-2+8% Ir(1-piq)₃ (20 nm)/Bphen (20 nm)/LiF:Al. The device, together with a desiccant, was then hermetically packaged in a dry glove box for protection against ambient environment.

A comparative example 1-2 was prepared in a similar manner to device 1-1 except Emitter-1 was replaced with 1% Emitter-2. Comparative example 1-3 is like device 1-2 except Emitter-2 is at 2.5%. Comparative example 1-4 is like device 1-3 except Emitter-2 is at 5%. EQE and color results are shown in Table 1.

TABLE 1
Electroluminescence results for Examples 1-1 thru 1-4 at 1 mA/cm².

| | Luminance Yield | External Quantum | |
|---|---|---|---|
| Example | (cd/A) | Efficiency (%) | CIE (x, y) |
| 1-1 (Inv) | 9.55 | 10.70 | 0.298, 0.182 |
| 1-2 (Comp) | 6.89 | 6.35 | 0.216, 0.173 |
| 1-3 (Comp) | 6.69 | 5.78 | 0.182, 0.166 |
| 1-4 (Comp) | 6.82 | 5.49 | 0.175, 0.179 |

As seen from the results in Table 1, inventive Example 1-1 gave an overall EQE of 10.70% with substantial blue and red emission as indicated by the CIE values. Example 1-1 has a fluorescent host with a HOMO level of −5.58 eV which is greater than 0.1 eV less negative than the HOMO level of Emitter-1 (−5.69 eV). However, comparative example 1-2 with the same host but with an emitter with a less negative HOMO level (the HOMO for Emitter-2 is −5.09) only gave 6.35% EQE. Moreover, Comparative example 1-2 gave mainly blue and very little red emission. In Comparative examples 1-3 and 1-4 where the dopant level was increased to give higher blue emission, the red emission was lessened as indicated by the CIE values.

It should be noted that in examples 1-1 to 1-4, the triplet energy of the fluorescent host (Host-8) is 2.67 which meets the requirement of ‘not more than 0.2 eV less’ than the triplet energy of Host-2 (2.21) which serves as both the spacer material and the phosphorescent host. In addition, the exciton blocking layer material TCTA (Host-6) in these examples has a triplet energy of 2.85 as compared to the fluorescent host Host-8 with a triplet energy of 2.67.

### EXAMPLES 2-1 TO 2-5

An EL device (Device 2-1) satisfying the requirements of the invention was constructed in the same manner as devices 1-1 to 1-4 with the following components: ITO/NPB (75 nm)/TCTA (10 nm)/Host-8+1% Emitter-1 (5 nm)/Host-13 (10 nm)/Host-13+8% Ir(ppy)3 (20 nm)/Bphen (25 nm)/LiF:Al

This device showed the emission from both the blue fluorescent dopant and the green phosphorescent Ir(ppy)₃ dopant. At 1 mA/cm², the luminance yield was 39.2 cd/A with CIE (x,y) of (0.232, 0.425) for an external quantum efficiency of 14.2%. The luminous yield and EQE were still higher at lower current densities. It should be noted that Host-13 (the spacer material and the phosphorescent host) has a triplet energy of 2.57 eV compared to Host-8 (2.67).

EL devices not satisfying the requirements of the invention were constructed in same manner as 2-1 except the blue fluorescent emitter was Emitter-2. The concentration was 1% in 2-2, 2% in 2-3, 5% in 2-4, and 7.5% in 2-5. Comparative example 2-2 having an emitter with a less negative HOMO level (the HOMO of Host-8 is −5.58; the HOMO for Emitter-2 is −5.09 vs −5.69 for Emitter-1) gave only 8.82% EQE. In comparative examples 2-3 thru 2-5 where the Emitter-2 level was increased in order to increase the blue component of emission, the green phosphorescent emission was decreased as indicated by the CIE coordinates in the table and the overall EQE decreased also.

TABLE 2
Electroluminescence results for Examples 2-1 thru 2-4 at 1 mA/cm².

| | Luminance Yield | External Quantum | |
|---|---|---|---|
| Example | (cd/A) | Efficiency (%) | CIE (x, y) |
| 2-1 (Inv) | 39.2 | 14.2 | 0.232, 0.425 |
| 2-2 (Comp) | 23.3 | 8.82 | 0.226, 0.401 |
| 2-3 (Comp) | 20.7 | 8.52 | 0.210, 0.362 |
| 2-4 (Comp) | 13.8 | 6.61 | 0.183, 0.301 |
| 2-5 (Comp) | 11.4 | 5.71 | 0.175, 0.284 |

### EXAMPLE 3-1

An EL device (Device 3-1) satisfying the requirements of the invention was constructed in the same manner as devices 1-1 to 1-4 with the following components: ITO/NPB (75 nm)/TCTA (10 nm)/Host-22+1% Emitter-1 (5 nm)/Host-13 (10 nm)/Host-13+8% Ir(ppy)3 (20 nm)/Bphen (20 nm)/LiF:Al

This device showed the emission from both the blue fluorescent dopant and the green (Ir(ppy)3) phosphorescent dopant. At 1 mA/cm2, the luminance yield was 33.2 cd/A with CIE (x,y) of (0.220, 0.380) for an external quantum efficiency of 13%. The luminous yield and EQE were still higher at lower current densities. The fluorescent host in this device has a HOMO of −5.59 eV and a triplet energy of 2.76 relative to the fluorescent emitter with a HOMO of −5.69 and the spacer material and phosphorescent host with a triplet energy of 2.57.

### EXAMPLE 4-1

An EL device (Device 4-1) satisfying the requirements of the invention was constructed in the same manner as devices 1-1 to 1-4 with the following components: ITO/NPB (75 nm)/TCTA (10 nm)/Host-8+1% Emitter-1 (5 nm)/Host-13 (10 nm)/Host-13+8% Ir(ppy)3 (5 nm)/Host-13+8% Ir(piq)3 (15 nm)/Bphen (25 nm)/LiF:Al

This device showed the emission from both the blue fluorescent dopant and both the green (Ir(ppy)3) and red (Ir(piq)3) phosphorescent dopants. At 1 mA/cm2, the luminance yield was 21.9 cd/A with CIE (x,y) of (0.266, 0.242) for an external quantum efficiency of 11.5%. The luminous yield and EQE were still higher at lower current densities.

### EXAMPLE 5-1

An EL device (Device 5-1) satisfying the requirements of the invention was constructed in the same manner as devices 1-1 to 1-4 with the following components: ITO/NPB (75 nm)/TCTA (10 nm)/Host-8+1% Emitter-1 (5 nm)/Host-13 (10 nm)/Host-13+1% Ir(piq)3 (2 nm)/Host-13+8% Ir(ppy)3 (18 nm)/Bphen (25 nm)/LiF:Al

This device showed the emission from both the blue fluorescent dopant and both the green (Ir(ppy)3) and red (Ir(piq)3) phosphorescent dopants. At 1 mA/cm2, the luminance yield was 20.4 cd/A with CIE (x,y) of (0.265, 0.293) for an external quantum efficiency of 11.8%. The luminous yield and EQE were still higher at lower current densities. A remarkable feature of this device is the very thin and dilute red phosphorescent layer that produced substantial red emission.

### EXAMPLE 6-1

An EL device (Device 6-1) satisfying the requirements of the invention was constructed in the following manner:
1. A glass substrate, coated with an approximately 25 nm layer of indium-tin oxide (ITO) as the anode, was sequentially ultrasonicated in a commercial detergent, rinsed in deionized water and exposed to an oxygen plasma for about 1 minute.
2. Next, a hole transporting layer (HTL) of N,N′-di-1-naphthyl-N,N′-diphenyl-4,4′-diaminobiphenyl (Host-7 or NPB) was vacuum deposited to a thickness of 75 nm.
3. An exciton/electron blocking layer (EBL) of 4,4′,4″-tris(carbazolyl)-triphenylamine (Host-6 or TCTA) was vacuum deposited to a thickness of 10 nm.
4. A 5 nm light emitting layer (LEL1) consisting of a mixture of Host-8 as the host, and Emitter-1 as a blue fluorescent emitter present at concentration of 1.5 wt. % relative to the host was then vacuum deposited onto the exciton blocking layer.
5. A spacer layer of undoped Host-13 having a thickness of 8 nm was vacuum deposited over LEL1.
6. Next, a 10 nm light emitting layer (LEL2) consisting of a mixture of Host-13 as the host, and Ir(ppy)₂C as a yellow phosphorescent emitter present at concentration of 8 wt. % was vacuum deposited onto the buffer layer.
8. An electron transporting layer (ETL) of 4,7-diphenyl-1,10-phenanthroline (Bphen) having a thickness of 37 nm was vacuum deposited over the LEL2.
9. 0.5 nm of lithium fluoride was vacuum deposited onto the EIL, followed by a 100 nm layer of aluminum, to form a bilayer cathode.

The above sequence completed the deposition of the EL device. Therefore, Device 6-1 had the following structure of layers: ITO/NPB (75 nm)/TCTA (10 nm)/Host-8+1.5% Emitter-1 (5 nm)/Host-13 (8 nm)/Host-13+8% Ir(ppy)₂C (10 nm)/Bphen (37 nm)/LiF:Al. The device, together with a desiccant, was then hermetically packaged in a dry glove box for protection against ambient environment.

This device showed the emission from both the blue fluorescent dopant and the yellow phosphorescent Ir(ppy)₂C dopant producing highly efficient hybrid white OLED. At 1 mA/cm², the luminance yield was 34.6 cd/A with CIE (x,y) of (0.317, 0.353) for an external quantum efficiency of 14.0%. The luminous yield and EQE were still higher at lower current densities. The color coordinates practically do not change with current density. It should be noted that Host-13 (the spacer material and the phosphorescent host) has a triplet energy of 2.57 eV compared to Host-8 (2.67).

### EXAMPLE 7-1

An EL device (Device 7-1) satisfying the requirements of the invention was constructed in the same manner as device 6-1 except that Host-20 was used in the spacer layer and as phosphorescent host for the yellow emitter in LEL 2. Thus, device 7-1 has the the following structure: ITO/NPB (75 nm)/TCTA (10 nm)/Host-8+1.5% Emitter-1 (5 nm)/Host-20 (3.5 nm)/Host-20+8% Ir(ppy)₂C (10 nm)/Bphen (41.5 nm)/LiF:Al.

The device showed white emission consisting of blue and yellow components. At 1 mA/cm², the luminance yield was 18.1 cd/A with CIE (x,y) of (0.283, 0.324) for an external quantum efficiency of 7.8%. The luminous yield and EQE were still higher at lower current densities. It should be noted that Host-20 (the spacer material and the phosphorescent host) has a triplet energy of 2.47 eV compared to Host-8 (2.67).

It will be evident to one skilled in the art that a high efficiency hybrid white OLED would be prepared by adding a red layer to the structure of Example 7-1 with appropriate optimization. One way to do this would be to substitute Ir(1-piq)3 or other red to orange phosphorescent dopant for some of the Ir(ppy)3, or adding a layer of Ir(1-piq)3 with Host-2 as a host on the cathode side of the layer containing Ir(ppy)3.

### EXAMPLE 8-1

An EL device (Device 8-1) satisfying the requirements of the invention was constructed in the same manner as device 1-1 except that Host-20 was used as the host in the LEL1, concentration of Emitter-1 was 1.5% relative to the host. Thickness of LEL 2 was 15 nm and thickness of Bphen layer was 35 nm. Thus, device 8-1 has the the following structure: ITO/NPB (75 nm)/TCTA (10 nm)/Host-20+1.5% Emitter-1 (5 nm)/Host-2 (5 nm)/Host-2+8% Ir(piq)₃ (15 nm)/Bphen (35 nm)/LiF:Al.

This device showed the emission from both the blue fluorescent dopant and the red phosphorescent Ir(piq)₃ dopant. At 1 mA/cm², the luminance yield was 9.13 cd/A with CIE (x,y) of (0.255, 0.166) for an external quantum efficiency of 9.9%. The luminous yield and EQE were still higher at lower current densities. It should be noted that Host-2 (the spacer material and the phosphorescent host) has a triplet energy of 2.21 eV compared to Host-20 (2.47).

It will be evident to one skilled in the art that a high efficiency hybrid white OLED would be prepared by adding a yellow layer to the structure of Example 8-1 with appropriate optimization. One way to do this would be to substitute Host-2 with Host-20 or other suitable host for the yellow to orange phosphorescent emitter.

The entire contents of the patents and other publications referred to in this specification are incorporated herein by reference. The invention has been described in detail with particular reference to certain preferred embodiments thereof, but it will be understood that variations and modifications can be effected within the spirit and scope of the invention.

### PARTS LIST

101 Substrate
103 Anode
105 Hole Injecting Layer
107 Hole Transport Layer
108 Exciton Blocking Layer
109 Fluorescent Light Emitting Layer (LEL)
110 Spacer Layer
111 Phosphorescent Light Emitting Layer (LEL)
112 Electron Transporting Layer
113 Cathode
150 Voltage/Current Source
160 Electrical Connectors

1. An OLED device comprising:
a) a fluorescent light emitting layer comprising a fluorescent emitter and a fluorescent host material wherein the HOMO energy level of the fluorescent host material is not more than 0.1 eV more negative than that of the fluorescent emitter;
b) a phosphorescent light emitting layer comprising a phosphorescent emitter and a phosphorescent host material; and
c) a spacer layer interposed between the fluorescent light emitting layer and the phosphorescent light emitting layer;
wherein the triplet energy of the fluorescent host material is not more than 0.2 eV less than the triplet energy of both the spacer layer material and of the phosphorescent host material.

2. The OLED device of claim 1 wherein the fluorescent host material has a HOMO energy level equal to or less negative than that of the fluorescent emitter.

3. The OLED device of claim 1 wherein the fluorescent host material has a HOMO energy level of −5.7 or less negative.

4. The OLED device of claim 3 wherein the fluorescent host material has a triplet energy of at least 2.2 eV or greater.

5. The OLED device of claim 1 wherein the fluorescent host material is a hole transporting material.

6. The OLED device of claim 5 wherein the fluorescent light emitting layer is on the anode side of the spacer layer and the spacer layer material and phosphorescent host are both electron-transporting materials.

7. The OLED device of claim 5 wherein the fluorescent light emitting layer is on the cathode side of the spacer layer, contacts an electron transporting material on the side opposite to the spacer layer, and the spacer layer material and phosphorescent host are both hole-transporting materials.

8. The OLED device of claim 1 wherein the fluorescent host material is selected from:
a) a tetraarylamine represented by formula (TADA): 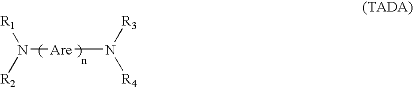
wherein
each Are is an independently selected arylene group;
n is an integer of from 1 to 4, and
R₁, R₂, R₃, and R₄ are independently selected aryl groups; or
b) a carbazole represented by formula (CAH-a): 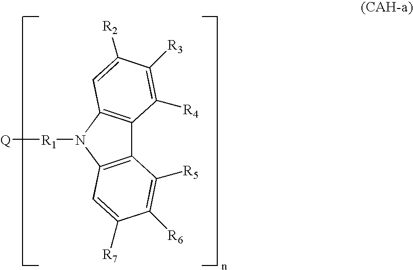
wherein:
Q independently represents nitrogen, carbon, an aryl group, or substituted aryl group, preferably a phenyl group;
R₁ is preferably an aryl or substituted aryl group, and more preferably a phenyl group, substituted phenyl, biphenyl, substituted biphenyl group;
R₂ through R₇ are independently hydrogen, alkyl, phenyl or substituted phenyl group, aryl amine, carbazole, or substituted carbazole; and
n is selected from 1 to 4.

9. An OLED device of claim 8 wherein the fluorescent host material is selected from

| | |
|---|---|
| Host-8 | 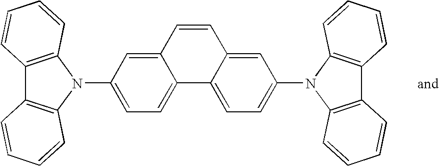 |
| Host-22 | 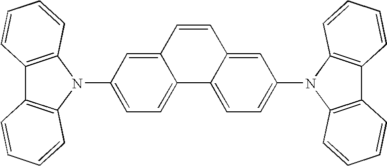 |

Host-8 or Host-22.

10. The OLED device of claim 1 wherein the spacer material is the same as the host material in the phosphorescent layer.

11. The OLED device of claim 1 wherein the spacer material is chosen from the following:
a) complexes represented by Formula (MCOH-b) 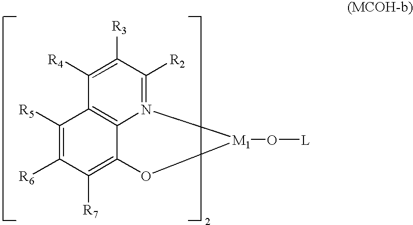
wherein:
M₁ represents Al or Ga; and
R₂-R₇ represent hydrogen or an independently selected substituent; and
L is an aromatic moiety linked to the aluminum by oxygen, which may be substituted with substituent groups such that L has from 6 to 30 carbon atoms; and
b) organic gallium complexes according to Formula (GH): 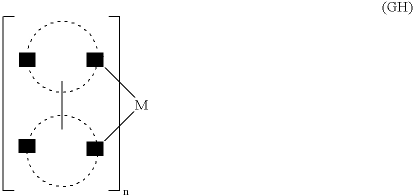
wherein:
M represents Gallium;
n is 3; and
each Z^{a} and each Z^{b} is independently selected and each represents the atoms necessary to complete an unsaturated ring and Z^{a} and Z^{b} are directly bonded to one another provided Z^{a} and Z^{b} may be further linked together to form a fused ring system; and
c) fluorene derivatives according to formula (SFH): 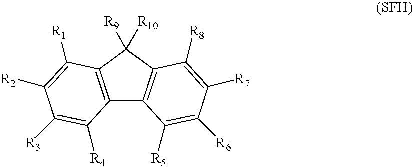
wherein R₁-R₁₀ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused or annulated aromatic ring including an additional fluorene group to form a bis-spirofluorene;
Group 4: heteroaryl or substituted heteroaryl of from 5 to 24 carbon atoms as necessary to complete a fused heteroaromatic ring;
Group 5: alkoxylamino, alkylamino, or arylamino of from 1 to 24 carbon atoms; and
Group 6: fluorine, keto, chlorine, bromine or cyano.

12. The OLED device of claim 1 wherein the spacer material is the same as the host material in the phosphorescent layer.

13. An OLED device of claim 1 wherein the host material of the phosphorescent light emitting layer is chosen from
a) complexes represented by Formula (MCOH-b) 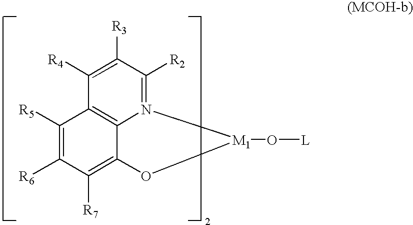
wherein:
M₁ represents Al or Ga; and
R₂-R₇ represent hydrogen or an independently selected substituent; and
L is an aromatic moiety linked to the aluminum by oxygen, which may be substituted with substituent groups such that L has from 6 to 30 carbon atoms; and
b) organic gallium complexes according to Formula (GH): 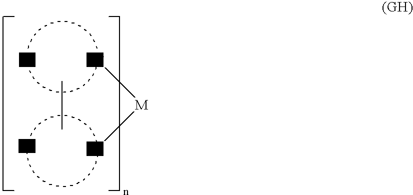
wherein:
M represents Gallium;
n is 3; and
each Z^{a} and each Z^{b} is independently selected and each represents the atoms necessary to complete an unsaturated ring and Z^{a} and Z^{b} are directly bonded to one another provided Z^{a} and Z^{b} may be further linked together to form a fused ring system; and
c) fluorene derivatives according to formula (SFH): 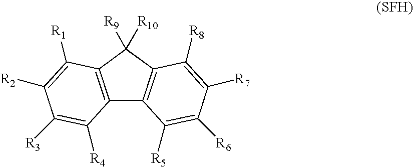
wherein R₁-R₁₀ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused or annulated aromatic ring including an additional fluorene group to form a bis-spirofluorene;
Group 4: heteroaryl or substituted heteroaryl of from 5 to 24 carbon atoms as necessary to complete a fused heteroaromatic ring;
Group 5: alkoxylamino, alkylamino, or arylamino of from 1 to 24 carbon atoms; and
Group 6: fluorine, keto, chlorine, bromine or cyano.

14. An OLED device of claim 1 wherein the fluorescent emitting layer host, the spacer layer material, and the phosphorescent emitting layer host are each electron-transporting; and
the fluorescent emissive layer contacts a hole transport material on the anode side; and
the spacer layer and phosphorescent light emitting are between the cathode and the fluorescent emissive layer.

15. An OLED device of claim 1 comprising a light emitting unit consisting of a first phosphorescent emissive layer, which is closest to the anode, a first spacer layer, a fluorescent emissive layer, a second spacer layer, and a second phosphorescent emissive layer, which is closest to the cathode, arrangement.

16. An OLED device of claim 15 wherein the host of the first phosphorescent layer and the material of the first spacer layer are each a hole transporting material and the host of the second phosphorescent layer and the material of the second spacer layer are each an electron transporting material.

17. An OLED device of claim 16 wherein the fluorescent emissive layer contains a host that is a hole transporting material.

18. An OLED device of claim 16 wherein the fluorescent emissive layer contains a host that is an electron transporting material.

19. An OLED device of claim 1 further comprising an exciton blocking layer adjacent to the fluorescent LEL on the opposite side of the fluorescent LEL from the spacer layer and phosphorescent LEL wherein the exciton blocking layer material has a triplet energy greater than that of the fluorescent host material by at least 0.15 eV.

20. An OLED device as in claim 19 wherein the exciton blocking layer material is according to formula (CAH-a): 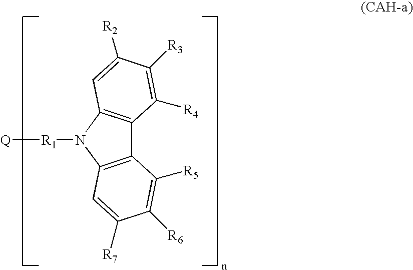
wherein:
Q independently represents nitrogen, carbon, an aryl group, or substituted aryl group;
R₁ is an aryl or substituted aryl group;
R₂ through R₇ are independently hydrogen, alkyl, phenyl or substituted phenyl group, aryl amine, carbazole, or substituted carbazole; and
n is selected from 1 to 4.

21. The OLED device of claim 20 where the exciton blocking material is TCTA.

22. The OLED device of claim 1 additionally includes a second light emitting unit that is separated from the hybrid fluorescent light emitting layer, spacer layer, phosphorescent light emitting layer unit according to a), b) and c) by a non-emitting connecting layer to form a stacked OLED device.

23. The OLED device of claim 19 additionally includes a second light emitting unit that is separated from the hybrid fluorescent light emitting layer, spacer layer, phosphorescent light emitting layer unit according to a), b) and c) by a non-emitting connecting layer to form a stacked OLED device.

24. A process for emitting light comprising applying an electrical potential to the device of claim 1.
